(19) United States
(12) Patent Application Publication
(10) Pub. No.: US 2005/0239675 A1
(43) Pub. Date: Oct. 27, 2005

(54) Carrier foam to enhance liquid functional performance

(76) Inventor: Munzer Makansi, Signal Mountain, TN (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/159,439

(22) Filed: Jun. 23, 2005

Related U.S. Application Data
(63) Continuation-in-part of application No. 10/867,069, filed on Jun. 14, 2004.
Application No. 10/867,069 is a continuation-in-part of application No. 10/402,169, filed on Mar. 28, 2003, now Pat. No. 6,756,352.
(60) Provisional application No. 60/369,366, filed on Apr. 1, 2002.

(51) Int. Cl. C11D 1/00

(52) U.S. Cl. 510/223

(57) ABSTRACT

A carrier fluid foam, which enhances the functional performance of liquids containing one or more special active agents to accomplish specific tasks such as cleaning and disinfecting, contains a liquid mixture of the functional active agent and a surfactant and has a particular combination of foam syneresis value, foam horizontal thickness half-life, and vertical wall clingability, and compared to liquids containing the same active agents, provides superior performance, normally without scrubbing. The carrier fluid foam is produced by vigorous agitation of the liquid mixture which contains the active agent and a surfactant in the presence of a gas, or by injection of a pressurized propellant into an aerosol dispenser containing such liquid mixture and then passing the liquid/propellant mix through a mechanical break-up actuator in the valve assembly of the aerosol dispenser.

### CROSS REFERENCE TO RELATED APPLICATIONS

This application is a continuation-in-part of U.S. application Ser. No. 10/867,069 filed Jun. 14, 2004, which is a continuation-in-part of U.S. application Ser. No. 10/402,169 filed Mar. 28, 2003, which claims priority to and the benefit of provisional application Ser. No. 60/369,366 filed Apr. 1, 2002. This application also claims priority to and the benefit of provisional patent application Ser. No. 60/509,931 filed Oct. 9, 2003 and provisional patent application Ser. No. 60/527,204 filed Dec. 5, 2003.

### BACKGROUND

1. Field of the Invention

This invention relates to a carrier fluid foam composition which enhances the functional performance of liquids containing special active agents to accomplish specific tasks, such as cleaning and/or disinfecting stained and soiled surfaces, the fluid foam composition comprising a solution of one or more of the active agents. More particularly, the invention concerns cleaner, lubricant, agricultural chemical, industrial chemical and medicinal compositions which are in the form of a fluid foam having a particular combination of characteristics and a process for preparing the composition fluid foam.

2. Description of the Prior Art

Various liquid cleaning products, lubricants, agricultural chemicals, industrial chemicals and medicinal products are available commercially for use in household, janitorial, agricultural and industrial uses. Also some liquid medicines are available for topical application on the skin with cotton swabs. These products contain active agents such as detergents to remove soil and oily stains, oxidizing compounds such as hydrogen peroxide and sodium hypochlorite to bleach and remove mold and mildew stains and kill germs and viruses, reducing agents to remove ink and rust stains, mild bases like sodium bicarbonate to remove soil and grease from window and other surfaces, alkali metal hydroxides such as sodium hydroxide to clean clogged sink drains or greasy ovens, organic and inorganic acids to remove calcium deposits, as well as other organic and inorganic compounds, used separately or in combination, for general and/or more specialized cleaning functions. Such products typically are contained in and dispensed from glass, metal or plastic bottles, some of which are equipped with hand-activated pumps for spraying the product composition on a surface. The sprayed compositions usually are dispensed as liquids, short-lived foams, thickened liquids or gels. Examples of such commercial products include but are not limited to: Scrubbing Bubbles, distributed by S.C Johnson, Inc., Lime Away, distributed by Reckitt Benckeiser, Inc., Orange Clean, distributed by Orange Glo International, Inc., and Windex, distributed by S.C. Johnson, Inc., WD-40 oil spray lubricant distributed by WD-40 Company of San Diego, Calif., Hot Shot Roach and Ant Killer distributed by Spectrum Group of United Industries, Inc. of Saint Louis, Mo., and Round Up Weed and Grass Killer, Ready-to-Use, distributed by Monsanto Company Lawn and Garden Products of Marysville, Ohio.

Several aqueous cleaning compositions for the removal of mildew stains, similar to those in the commercial products, are disclosed in patents, such as U.S. Pat. No. 5,281,280 (Lisowski et al), U.S. Pat. No. 5,290,470 (Dutcher et al), U.S. Pat. No. 5,567,247 (Hawes).

The present inventor found that although some of the known cleaning compositions perform satisfactorily as claimed on the label, some did not perform their cleaning functions at all, some were effective in removing only mild stains, some required repeated applications and some others required vigorous scrubbing.

The use of thickening agents to increase viscosity and change flow characteristics of aqueous cleaning compositions in order to improve their cleaning ability is disclosed in various patents, as for example in U.S. Pat. No. 5,549,842 (Chang), U.S. Pat. No. 4,900,467 (Smith), U.S. Pat. No. 4,800,036 (Rose et al), and U.S. Pat. No. 4,337,163 (Schilp). The thickened liquids usually are disclosed for use as detergents in dish washers, sink drains and laundry washers, and some are also suggested for removing mildew.

Although the known aqueous cleaning compositions are useful for removing some stains from surfaces, improvements are desired to their cleaning efficiency, so that multiple application cycles or scrubbing and/or high-pressure water-hosing, or longtime waiting, after the cleaning composition is applied on a stained surface, are normally not required.

### SUMMARY

The present invention provides a carrier fluid foam composition with a combination of properties, which enhances the functional performance of liquids containing special active agents to accomplish specific tasks. Exemplary tasks include cleaning and/or disinfecting stained and soiled surfaces, more efficiently, faster, easier and normally without scrubbing. The composition is of the type that comprises a solution of active agent. Exemplary active agents include one or more of a cleaning agent, disinfecting agent, lubricating agent, agricultural chemical agent, household pest control formulations, herbicides, pesticides, fungicides, chemicals, industrial chemicals, institutional chemicals, medicinal chemicals, cosmetics, pharmaceutical chemicals, quaternary ammonium compounds, terpenes, and mixtures of surfactants and chelating agents. The composition also comprises a compatible surfactant or a mixture of surfactants. Suitable surfactants include anionic, cationic, non-ionic, and amphoteric surfactants that are incapable of interacting substantially adversely with any of the ingredients of the carrier fluid foam composition or the dispenser device components with which they come in contact. Exemplary surfactants include cocamine oxides such as N-alkyl(C₁₂₋₁₆)-N,N-dimethylamine oxide, sodium alkyl alkanoate, sodium dodecyl diphenyl disulfonate, sodium dodecyl diphenyl oxide disulfonate, cocamidopropyl amine oxide and octyl phenoxy polyethanol or mixtures thereof. In an exemplary embodiment the surfactant or mixture of surfactants is present in a concentration range of 0.05 to 20%. The carrier fluid foam composition is a fluid foam that has, in combination, as measured by methods described hereinafter, (a) a syneresis value in the range of 1 to 60%, preferably in the range of 2-40%, (b) a foam horizontal thickness half-life of at least 8 minutes, preferably at least 12 minutes, and (c) a vertical-surface clingability of at least 4 minutes, preferably at least 7 minutes and more preferably at least 9 minutes.

The invention also provides a method for forming the above-described composition fluid foam. In an exemplary embodiment, the method comprises (a) preparing a solution of the active agent and a compatible surfactant in a container and (b) vigorously agitating the solution in the presence of a gas with mechanical stirrers or by fluidic/pneumatic action of a fluid jet, preferably produced by a mechanical breakup actuator of an aerosol dispenser in the presence of propellant. In an exemplary embodiment, the foam is produced with a low-boiling hydrocarbon propellant in an aerosol dispenser made of materials compatible with the composition. Suitable propellants include propane, butane, isobutane and mixtures thereof and also Diethylether, 1,1,-Difluoromethane, 1,1,1,2-Tetrafuoroethane and mixtures thereof, in a concentration of 1 to 20%, preferably 2 to 10%, by weight of the composition. In an exemplary aerosol dispenser, all parts and surfaces that contact the composition are of compatible metal, rubber, glass or plastic. Suitable plastic materials include polyethylene, polypropylene, nylon, polyamides, polyimides, polyester, polyvinyl chloride, epoxy polymers, acrylic and methacrylic polymers, glass fiber reinforced polymers and their combinations.

A foam drip catcher device may also be provided, which can be attached to the spray cap of an aerosol dispenser to collect the residual foam, which oozes out of the dispenser nozzle while in the off position after use.

An extension tube may further be provided, which can be attached to dispenser sprayer in order to spray hard-to-reach hidden places and also to prevent foam from dripping on the user's hand.

### BRIEF DESCRIPTION OF THE DRAWINGS

The invention will be more readily understood by reference to the accompanying drawings, in which:

FIG. 1 is a side elevational view of a graduated glass cylinder 10 in which the heights of foam 11 and separated liquid 12 are measured during a “syneresis value” test and wherein h₀ is the original height of the foam in the filled cylinder at the start of the test, and h₁ and h₂ are respectively the thickness of the separated liquid layer and the thickness of the foam layer at a given time during the test.

FIG. 2 is a schematic representation of an aerosol dispenser suitable for dispensing a fluid foam of the invention.

FIG. 3A is a front view, and FIG. 3B is a side view of schematic representations of a foam drip catcher designed to be attached to the front end of the horn of a spray cap.

FIG. 4A is a top view, FIG. 4B is a front view and FIG. 4C is a side view of schematic representations of a foam drip catcher chamber designed to be attached to a sprayer.

FIG. 5 is a graphical representation of experimental data, obtained by the inventor, which compares the cleanability levels of the mildew cleaner products of the carrier fluid foam of this invention with commercial mildew cleaner products available on the market in the form of liquid sprayed from hand held pump dispensers.

FIG. 6 is a graphical representation of experimental data, obtained by the inventor, which show the effect of propellant level on syneresis value of fluid carrier foams produced from precursor solutions comprising sodium hypochlorite as the active agent, different levels of Barlox 12 surfactant, two types of propellants and two types of fragrances.

### DETAILED DESCRIPTION OF EXEMPLARY EMBODIMENTS

The following detailed description of exemplary embodiments of the present invention is included for purposes of illustration and is not intended to limit the scope of the invention. The scope is defined by the claims appended below.

Definitions

For convenience and clarity, the meaning will now be given of several terms and characteristics that are used to describe the invention. Descriptions of tests employed to quantitatively measure some of the characteristics follow the list of definitions.

“Mildew” refers to any one or combination of mycological stains including household mildew, algae, fungus, spores etc.

“Liquid” refers to a single liquid, a liquid solution, an emulsion of two liquid phases, a suspension of a solid phase in a liquid phase or a dispersion of a liquid or a solid phase in a liquid phase and said liquid forms a visibly distinguishable layer from a layer of fluid foam formed from said liquid and is in contact with it at the interface between the two layers upon settling down on a horizontal surface as described in the “Syneresis Value and Foam Horizontal Thickness Half-life” test described herein after.

“Fluid foam” in the context of this disclosure refers to an aggregate of gas bubbles adhering together and carrying liquid in or around their filmy cell walls, then spontaneously releasing such liquid with time either (a) onto a surface in contact with the fluid foam to wet it or (b) into a container holding such fluid foam to form a liquid phase layer, on the bottom of the container, which is separate and clearly distinguishable from the foam phase layer above it.

“Active agent or functional active agent” in the context of this disclosure refers to a substance in the liquid, other than a surfactant component, which reacts or interacts with the object surface to accomplish an intended function such as cleaning, disinfecting, bleaching, removing, curing, etc.

“Compatible” means that a particular material or substance being referred to does not substantially adversely affect functional performance or efficiency of a fluid foam of the invention or the performance of its dispenser device.

“Surfactant” in the context of this disclosure refers to a surface active agent from anyone of the families of anionic, cationic, non-ionic, amphoteric or microfine or nanoparticles active agents which changes the interfacial tension between two liquids or between a liquid and a gas. Examples of anionic surfactants are linear and branched alkyl sulphates and sulphonates, alkyl ether sulphates, phosphate esters, fatty acids and soaps. Examples of cationic surfactants are quarternary ammonium compounds, fatty amine salts, fatty acid amides, imidazolines. Examples of non-ionic surfactants are alkyl phenol ethoxylates, alkyl polyglycosides, ethoxylate propoxylate polymers, and fatty alcohol ethoxylates. Examples of amphoteric surfactants are alkyl betaines. Examples of microfine or nanoparticles are polyamide and polymethacrylates. More particularly, it refers to surfactants that are compatible with the active agent(s) and with the components of the dispenser device with which they come into contact, and that cause the formation of bubbles upon agitating such liquid in the presence of gas.

“Stubborn mildew stain” refers to gray or black mildew which grows on a surface over a long period of time during which the mildew color typically changes from yellow to pink to green and finally to gray and black.

“Clingability” refers to the ability of a foam to cling or adhere to a vertical surface, measured as described herein below.

“Osterizer” refers to an electric mixer, usually used in food preparation, but employed herein to prepare fluid foams of various compositions, as reported in the Examples.

“Pouched dispenser” or “barrier dispenser” refers to a pressurized dispenser in which the solution is contained inside a pouch made of materials compatible with the solution. The pouch itself being suspended from and sealed to the dispenser valve or mounting cup and not in intimate contact with the inner walls of the dispenser.

“Cleanability” refers to a numerical ranking of the degree of whiteness or color shade change that occurs as a result of the application of a cleaning composition to a stained panel, measured as described herein below.

“Precursor solution” refers to the composition of the liquid, which comprises active agent, surfactant and optional additives, prior to conversion of the liquid into a fluid foam.

“Syneresis value” is a measure of the amount of liquid that separates from a fluid foam, measured as described herein below.

“Horizontal thickness half-life” is the time interval required for a fluid foam to lose 50% of its thickness, as measured in the syneresis value test.

“Actuator with mechanical breakup” refers to a known actuator which incorporates a feature to reduce spray particle size (e.g., a circular or near circular swirl chamber, or a channel with several tangential entries).

“Soap scum” refers to accumulation of film deposits on bath tub, walls, glass doors or curtains in bathroom shower space, which form as a result of contact with splashed soap water from human skin during showering.

“NP-31” propellant or “NA-31” propellant refers to an Aeron® propellant mixture of hydrocarbons consisting of 81.3% n-butane, 16.6% propane and 2.1% isobutane, and having a nominal vapor pressure of 225 KPa (33 psig). It is supplied by Diversified Propellant Company International, Inc, U.S.A.

“NP-70 propellant” or “NA-70” propellant refers to an Aeron® propellant mixture of hydrocarbons consisting of 42.5% n-butane, and 57.5% propane and having a nominal vapor pressure of 483 KPa (70 p sig). It is supplied by Diversified Propellant Company International, Inc, U.S.A.

“Sirena® Integrated Spray Cap” is a spray cap, which replaces the actuator button on an aerosol dispenser. It is supplied by Seaquist Perfect Dispensing of Gary, Ill., U.S.A.

ACC-U-SOL® Sprayer is another type of spray cap, which replaces the actuator button on an aerosol dispenser. It is supplied by Precision Valve, Inc. of Yonkers, N.Y., U.S.A.

Test Procedures

Mildew Cleanability. The cleaning effectiveness of different products, to remove mildew stain, is tested on a landscaping timber that has stubborn mildew stains distributed over its surface. The stained landscaping timber typically measures 240 cm. (8 feet) in length and about 7.2 cm. (3-in) by 10.2 cm. (4 inch) in rectangular cross-section with rounded edges. Landscaping timbers of this type frequently are found in yard or garden areas around residential homes. When exposed to the environment of a humid climate for a long time (e.g., a few years), the timbers become covered with a layer of a high intensity gray or black, stubborn mycological stains. Such stained timbers are ideal for running a large number of test items in a relatively short time (about 10 items per hour) to evaluate and compare, side by side, the effectiveness of different mildew removers. In preparation for a series of cleanability tests, a landscaping timber is placed horizontally on the ground with the longer side of its cross section perpendicular to the ground. The timber is then marked with vertical lines to divide the timber into test panels of about 5-cm width. The panels are numbered for identification. Every other panel is used as a test panel on which a sample of the cleaning composition being tested is placed for a predetermined period of time. At the end of the time period, the test panel is rinsed with water. The non-treated stained alternate panels on each side of the test panel serve as controls. The use of two separate control panels for each test panel helps reduce experimental variability associated with cleanability rating determinations including the effect of possible presence of mildew intensity variation within some landscaping timbers.

At the completion of the tests and the rinsing with water without scrubbing the test panels are allowed to dry. Then, the cleanliness of each test panel is measured relative to its adjacent controls by a method known as “Gray Scale for Evaluating Changes in Color”, referred to as ISO International Standard R105/1, Part 2. According to this method, the difference between the color of the test item and its adjacent controls is matched with the closest contrast between gray color pairs printed on a standard template. The scale on the gray scale template extends from 1 for the largest difference in color contrast to 5 for no visible contrast difference, with fractions in between making a total of 10 gray scale panel pairs. By use of standard tables published with the Gray Scale method, the numbers obtained from the gray scale comparison are converted to “Total Color Difference” expressed in “CIE Lab Units”. The total Color Differences range from zero CIE Lab Units for a gray scale rating of 5 to 13.7 CIE Lab Units (reported herein for simplicity as 14) for a gray scale rating of 1. In the examples below, all cleanability ratings are reported in CIE Lab Units.

Relative Viscosity. The relative viscosity of a precursor solution i.e., the solution of active agent, surfactant and optional additives, prior to conversion into a carrier fluid foam) is measured herein by a simple laboratory apparatus having a vertical arrangement of an upright conical plastic funnel with an outlet tube attached and sealed to a plastic capillary tube. The internal diameter of the circular upper end of the funnel is 5.1 cm. The diameter of the circular lower end of the funnel is 0.64 cm. The distance between the upper and lower ends of the conical portion of the funnel is of 4.5 cm. An exit stem extends 2.5 cm from the lower end of the funnel. A 17.8-cm long capillary tube of 0.1-cm internal diameter is inserted 2.0 cm into the end of the funnel stem and sealed thereto. The total capacity of the apparatus from the upper end of the funnel to the outlet end of the capillary tube is 35 cm³. All flows through the apparatus are measured at 21° C. To determine the relative viscosity of a liquid, (a) the apparatus is first completely filled with the liquid, (b) the time required for the liquid to flow through the apparatus is measured and (c) the time required for the same volume water to flow through the apparatus is measured. The relative viscosity, RV, of the aqueous liquid is defined as the ratio of tₜₑₛₜ to t_{water}, where tₜₑₛₜ is the measured time for the test liquid to flow through the apparatus and t_{water} is the measured time for water to flow through the apparatus. Relative viscosities at different shear rates are obtained by repeating the procedure with capillaries of different dimensions. The relative viscosities reported herein were measured on precursor solution at a shear rate of 7 sec⁻¹.

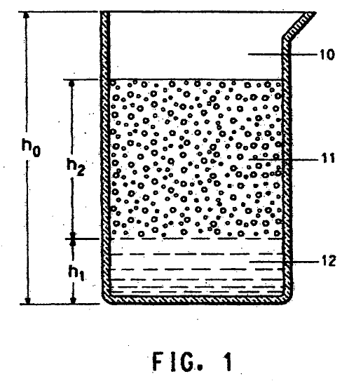

Syneresis Value and Foam Horizontal Thickness Half-life. The syneresis value and the horizontal thickness half-life of a fluid foam are measured with a graduated plastic or glass cylinder, as depicted in FIG. 1. The cylinder is initially filled completely to its full internal height h₀ with a carrier fluid foam composition and the cylinder is placed upright on a horizontal surface. The thickness h₂ of foam layer 11 and the thickness h₁ of separated liquid layer 12 are measured as functions of time during the test. The “syneresis value”, SV of the fluid foam, is expressed as a percentage of the initial thickness of the foam and is calculated by the formula, SV=100(h₁/h₀). Because the syneresis value rarely changes after 45 minutes of testing, the syneresis values reported herein were based on measurements made at about 45 minutes. A graph is prepared of the thickness h₂ of the foam, expressed as a % of the initial foam thickness h₀, versus time and the horizontal thickness half-life of a carrier fluid foam composition is determined as the time (measured from the start of the test) at which 100(h₂/h₀) equals 50%.

Vertical Surface Clingability. The ability of a carrier fluid foam or other aqueous cleaning composition to cling to a vertical surface is measured as follows. A test fluid foam is sprayed onto or otherwise applied in sufficient quantity to substantially cover a vertical 7.2-cm. by 10.2 cm. test panel on one side of a landscaping timber (of the type described above in the “cleanability” test). With increasing time after application, the area covered by the foam shrinks. A graph is constructed of the % of the area covered by the shrinking test foam as a function of time after application. The vertical clingability reported herein is defined as the time required for the area of the applied test foam to shrink to 50% of its initial area coverage.

Carrier Fluid Foam

A typical composition in accordance with an exemplary embodiment of the present invention is a carrier fluid foam that contains (a) a solution of the primary active agent, (b) a compatible surfactant, or a mixture of surfactants, in a concentration range of 0.05 to 20%, such as a cocamine oxide, (c) other optional enhancing agents, such as compatible fragrance, and (d) one or more optional additional compatible secondary active cleaning agents. The fluid foam composition has a combination of functional performance characteristics that provide greatly improved efficiency to the product. The functional performance characteristics of the composition foam are (a) a foam syneresis value in the range of 1 to 60%, preferably 2 to 40%, (b) a foam horizontal thickness half-life of at least 8 minutes, preferably at least 12 minutes, and (c) a foam vertical-surface clingability of at least 4 minutes, preferably at least 7 minutes, and more preferably at least 9 minutes. Because of this combination of characteristics, the present composition carrier fluid foam brings into contact with an applied surface substantially larger amounts of stain-removing, lubricating, agricultural chemical or medicinal active agents for longer reaction times than is provided by known compositions of equal concentrations applied to a surface in the form of a sprayed liquid, a short-lived foam, a thickened liquid or a gel. The superior efficiency of the carrier fluid foams disclosed herein compared to other known products of similar composition is believed to be a result of the liquid-rich cells of the carrier fluid foam clinging strongly to the applied surface and said cells breaking up slowly so that a continuous source of the active agent(s) is efficiently delivered to the applied surface. Thus, a carrier fluid foam of the present disclosure has a longer contact time with the applied surface and provides a greater amount of primary agent(s) to react with the intended object.

For example, the performance effectiveness and product utilization rate of an exemplary mildew cleaner carrier fluid foam composition of the present disclosure and one of the best commercial mildew cleaner products, Tilex Mildew Root, that sprays as sudsy liquid, were compared side by side on a vertical porcelain tile wall in a bathroom shower enclosure. The comparison showed that it takes 90 cycles of finger pumping actions on the trigger, which deliver 58 grams of sudsy liquid cleaner, to fully cover and clean one square foot of vertical surface stained with mild mildew using the commercial product. By contrast, it takes only one button pressing, which delivers 8 grams of liquid from the present foam dispenser, in the form of foam, to fully cover and clean the same size of one square foot of surface area stained with mild mildew.

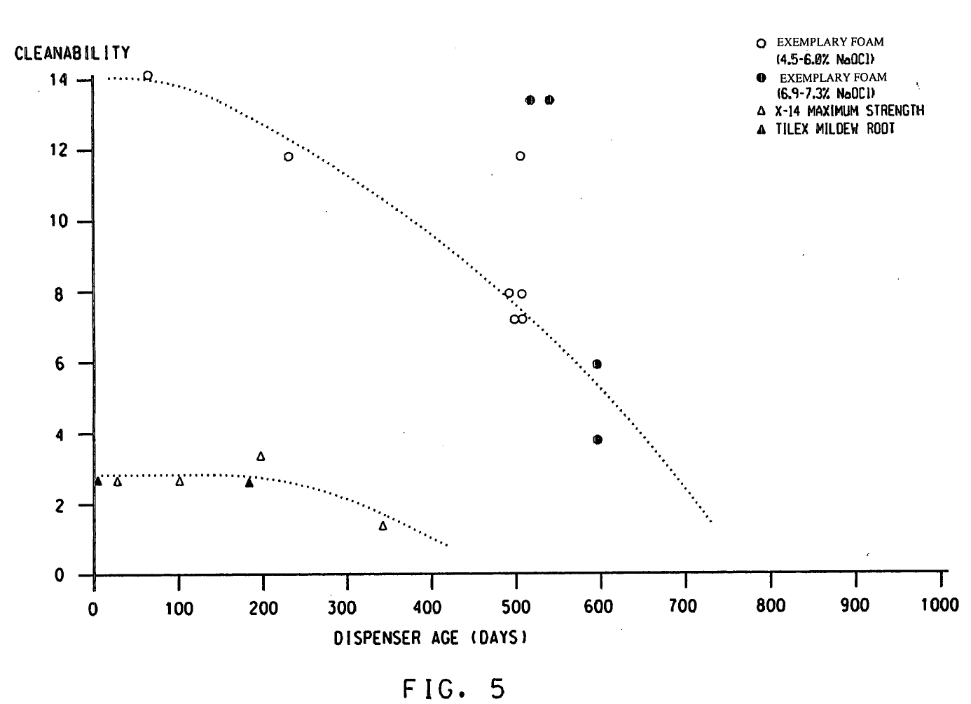

For stubborn mildew stain, as in the aforementioned landscaping timber test, one application of the commercial product lasting 10 minutes produces a cleanability rating of 3 and it takes 7 consecutive such applications lasting a total of 70 minutes to clean a vertical surface stained with stubborn mildew to a cleanability rating of 14 using the same commercial product. By contrast, it takes only one application lasting 10 minutes to clean the same area to the same cleanability rating of 14 with the foam product of present disclosure. In addition a shelf life test extending over 600 days shows that the cleanability of the carrier foam of this disclosure remains superior to the commercial products over the entire period. The data from this test are plotted graphically in FIG. 5, which shows that mildew cleanability rating is reduced with time using either product. This is a result of a well known spontaneous decomposition reaction inherent in sodium hypochlorite at room temperature. However, FIG. 5 shows that the cleanability rating of the carrier foam of this disclosure continues at a level about four times as high as the commercial products for a long time and it drops to a level of 4 at 600 days which is equal or greater than the cleanability of the commercial products, which clean at a rating of only 3-4 even on the first day of the shelf life test.

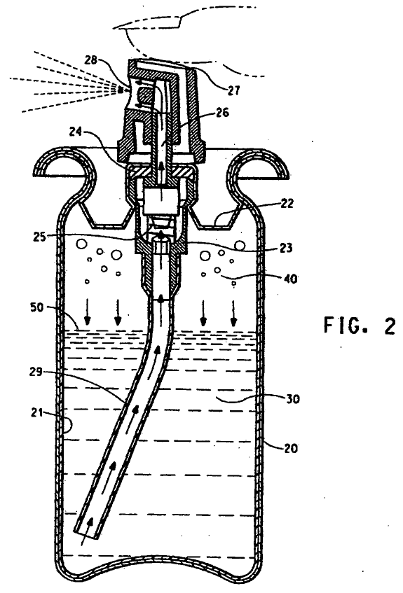

Additional enhancements provided by the carrier foam disclosed herein include: (a) a cleansing detergent action which removes dirt, soil and oil stains from the treated surface while removing other stains or killing germs and viruses, (b) an ability of the foam to float and remain stable on water surface for relatively long time (at least 30 minutes) to clean the stains frequently formed at the edge of stagnant water in a container, such as mildew and rust stains in a toilet bowl, and (c) user friendliness. When the carrier foam is delivered by an aerosol dispenser, of the type shown in FIG. 2, the jet flow is delivered continuously with one pressing of the finger on the actuator button. The jet stream can be directed to a surface oriented at any angle, even when the dispenser is in used in the inverted position as in toilet bowl cleaning. Also the use of the present carrier foam product avoids the need for hand pumping, the flow interruption and the jet starvation in inverted dispenser orientation, which are normally associated with the finger trigger pumped spray dispensers. The carrier foam properties of horizontal surface stability and floating characteristics can also be utilized effectively in cleaning oil spills from continental shores. In this case an appropriate active agent can be used with the proper surfactant, such as cocamine oxide, in a precursor solution. The solution can then be vigorously agitated and delivered to the stained water surface using either a large aerosol dispenser, scaled up to the size of a large pressurized gas cylinder, or by mechanical agitation in a continuous process device equipped with a stirrer similar to that of the Osterizer. Such devices can also be used to produce and spray the carrier foam of this invention to large areas in industrial or agricultural applications using industrial or agricultural chemicals with appropriate surfactants or mixtures of surfactants.

Suitable primary functional active agents include: organic acids, and inorganic acids; aldehydes, ketones, simple straight chain mono-functional alcohols; mono-functional ethers); esters; organic bases; and, alkali metal hydroxides, carbonates and silicates; oxidizing agents and bleaching agents; terpenes; mixtures of a surfactant and a chelating agent; topically applied liquid medications and disinfectants; commercially formulated liquid cleaners; lubricants; and chemicals used in household, industrial, agricultural, and institutional applications; cosmetics; pharmaceutical applications; and quaternary ammonium compounds.

Examples of suitable organic and inorganic acids include acetic acid, oxalic acid, citric acid, sulfuric acid, hydrochloric acid, nitric acid, phosphoric acid and sulfamic acid and salts thereof. Examples of suitable organic bases include amines, salts of amines and salts of ammonia. An example of a suitable amine is monoethanolamine. Examples of suitable alkali metal hydroxides, carbonates and silicates include sodium hydroxide, potassium hydroxide, lithium hydroxide, sodium carbonate, potassium carbonate, calcium carbonate, lithium carbonate, sodium metasilicate and sodium orthosilicate. Examples of suitable oxidizing and bleaching agents include sodium chlorite, potassium chlorite, lithium chlorite, hydrogen peroxide, and alkali metal hypochlorites such as sodium hypochlorite, potassium hypochlorite and lithium hypochlorite. Examples of suitable quaternary ammonium compounds include alkyl dimethyl benzyl ammonium chloride, alkyl dimethyl ethyl benzyl ammonium chloride, alkyl dimethyl benzyl ammonium bromide, alkyl dimethyl ethyl benzyl ammonium bromide and alkyl dimethyl ammonium saccharinate. An example of a suitable mixture of a surfactant and a chelating agent is a cocamine and a chelating agent like ethylene diamine tetraacetic acid. Examples of suitable topically applied liquid medications include disinfectants, coagulants, anesthetics, antibiotics and anti-bacterial agents and particularly include hydrogen peroxide, and ethanol.

Additional examples of suitable functional active agents include: methyl alcohol, ethyl alcohol, propyl alcohol, butyl alcohol and other higher molecular weight straight chain mono-functional alcohols; dimethyl ether, methyl ethyl ether, diethyl ether, and other higher molecular weight mono-functional ethers; and methyl acetate, ethyl acetates, propyl acetate, amyl acetate, and other higher molecular weight esters.

Examples of suitable commercially formulated liquid cleaners include “Rust Stain remover” by Whink Products Co., “Lime Away” by Reckitt Benkeiser, “Pine-Sol” by Clorox, Inc., Turtle Wax 2001 foaming wheel cleaner and Turtle Wax platinum ultrabrite wheel cleaner by Turtle Wax, Inc., Chicago, Ill., Black Magic no scrub wheel cleaner by Pennzoil Quaker State Company of Houston, Tex., Eagle one all wheel and tire cleaner by Eagle One, Inc of Lexington, Ky., Grease lightning auto and shop cleaner degreaser by A&M Cleaning Products of Clemson, S.C., Westleys Bleche white for tires by Blue Coral Stick 50 Ltd of Cleveland, Ohio, Bug Wash and Wax by Aiken Chemical Company of Greenville, S.C., Armor All Tire Foam by Armor All Products of Oakland, Calif., F21 Tire Foam and Shine by 2004 Turtle Wax Inc of Chicago, Ill., Tilex Fresh Shower by Clorox Company of Oakland, Calif., Clean Shower Daily Soap Scum and Mildew Remover by Arm & Hammer Company of Princeton, N.J., Sno Bol toilet bowl cleaner by Church and Dwight Company of Princeton, N.J., Kaboom shower, tub and tile cleaner by Orange Glo International, Littleton, Colo., Clorox Bathroom Cleaner with Teflon by Clorox Company of Oakland, Calif., Bug and Tar Remover by Letter 1 Products of Lenexa, Kans., BBQ Grill Cleaner by Magic American Products of Cleveland, Ohio, Mr Clean Antibacterial by Procter and Gamble of Cincinnati, Ohio, Simple Green all purpose cleaner by Sunshine Makers of Huntington Beach, Calif., Formula 409 all purpose cleaner by Clorox Company of Oakland, Calif. Grease Lightning orange blast super strength household cleaner by A&M Cleaning Products of Clemson, S.C., Top Job all purpose cleaner by Changing Paradigm, LLC, West Chester, Ohio, Goo Gone all purpose cleaner by Magic American Products, of Cleveland, Ohio, Iron Out rust and stain remover by Iron Out, Inc. of Fort Wayne, Ind., Krude Kutter concentrated cleaner degreaser/stain remover by Supreme Chemicals of GA Inc, of Cumming, Ga., CLR Enhanced Formula Bathroom & Kitchen cleaner by Jelmar of Skokie, II, Johnson Wax professional bathroom and bowl cleaner by 2002 S.C. Johnson Commercial Markets, Inc of Sturtvent, Wis., and Johnson Wax Professional Mildew Remover with bleach by 2002 S.C. Johnson Commercial Markets, Inc, Sturtvent, Wis.

Examples of suitable lubricants include WD-40, distributed by WD-40 of San Diego, Calif. And Liquid Wrench Super Penetrant, distributed by Radiator Specialty Company of Charlotte, N.C., Silicone Multi-Purpose Lubricant, distributed by CRC Industries, Inc. of Warminster, Pa. and Elmer's Slide—All with TEFLON Dry Spray lubricant, distributed by Borden, Inc., Dept. CP, Columbus Ohio.

Examples of suitable commercially formulated household, industrial and agricultural chemicals include herbicides, pesticides and fungicides such as Hot-Shot Roach and Ant Killer, distributed by Spectrum Group of United Industries, Inc. Round-Up Weed and Grass Killer, Ready-to-Use, distributed by Monsanto Company Lawn and Garden Products of Marysville, Ohio., Weed-B-Gone, distributed by Ortho Group of Columbus, Ohio., Bug-B-Gone, distributed by Ortho Group of Columbus, Ohio., Triozicide, distributed by Spectrum Group of United Industry, Inc. of Saint Louis, Ohio., Ortho Garden Disease Control, distributed by Ortho Group of Columbus, Ohio.

Suitable surfactants include those selected from surfactant families that are capable of converting the particular precursor liquid composition to fluid foam and that are also compatible with the one or more primary active functional agents used including the chemical families of anionic, cationic, non-ionic and amphoteric surfactants and combinations thereof. Suitable surfactants must meet two tests of compatibility with the functional active agent. The first is a foaming test which shows that the solution comprising the surfactant and active agent does indeed form a thick fluid foam when agitated vigorously in the presence of gas as in an Osterizer. The second test is a shelf life stability test. It should show that the surfactant and active agent do not interact substantially adversely over a long period of several months. This test requires chemical and/or physical measurements of changes in solution stability indicator properties such as pH, temperature, color, phase change, etc.

Examples of surfactants, found by the inventor, which are not suitable to form the fluid carrier foam of this disclosure when combined with the sodium hypochlorite as the functional active agent include: (1) Colatrope® 1A2 (sodium dodecyl diphenyl oxide disulfonate) and (2) Colonial ZF10 (a low foaming non-ionic surfactant), both of which are marketed by Colonial Chemical Company, Inc. of South Pittsburgh, Tenn. These two products failed the Osterizer foam test because they produced very thin and/or slippery foams. A surfactant which formed a foam meeting the functional performance properties of the carrier foam of this disclosure but which failed the shelf life stability test with the sodium hypochlorite as the active agent, is Triton® X-100 (octyl phenoxy polyethanol) marketed by Dow Chemical Company, Inc of Midland, Mich. Upon mixing the composition ingredients, the solution exhibited an immediate slow rise in temperature amounting to about 4 degrees Celsius in 400 minutes. This indicated an interaction between the surfactant and the active agent. The corresponding foam product exhibited a relatively very short life. The mildew cleanability dropped from 14 color units on the day of preparation to 2.5 on the tenth day of shelf life. This compares with a shelf life of about 700 days for the carrier foam mildew cleaner of this disclosure. This example does not rule out the use of Triton® X-100 as a suitable and compatible surfactant with active agents other than alkali metal hypochlorite.

Examples of surfactants found by the inventor which are suitable and compatible with alkali metal hypochlorites as active agents for use with household cleaner compositions include non-ionic surfactant Barlox®-12 which is a cocoamine oxide (N-alkyl (C₁₂₋₁₆)-N,N-dimethylamine oxide marketed by Lonza Specialty Chemical Company of New Jersey, Colatrope® SC-45 (sodium alkyl alkanoate, an anionic surfactant with sulfonate and carboxylate functionality), Colatrope® 1254 (sodium dodecyl diphenyl disulfonate, an anionic hydrotropic surfactant) and Colalux® CAO-35 (cocamidopropyl amine oxide and mixtures thereof. The last three surfactants are marketed by Colonial Chemical of South Pittsburgh, Tenn. Some of these surfactants, like the cocamine oxides, may be suitable for use with many different active agents as will be illustrated in the examples. The surfactant Triton® X-100, while not suitable with alkali hypochlorite active agents, may work well with other non-oxidative active agents.

Another family of potentially suitable surfactants includes liquid detergent formulations used in household applications including but not limited to: Dial® liquid soap (contains ammonium lauryl sulfate and sodium lauryl sulfate) marketed by Dial Corporation of Scottsdale, Ariz., Palmolive® liquid soap marketed by Colgate Palmolive company of New York and Johnson® baby shampoo marketed by Johnson & Johnson of New Jersey.

Suitable optional enhancing agents include fragrances, such as “Fresh”, “Rain Fresh”, “Floral”, “Lemon”, “Orange”, “Vanilla”, “Winter Green”, “Cherry” and “Citrus”,”. Other suitable enhancing agents include coloring material and surface shining agents, such as waxes, to enhance visual aesthetics, antibiotic agents to prevent wound infection, such as iodine solution, and coagulating agents, such as alum (potassium aluminum sulfate), to stop skin bleeding.

Suitable optional additional compatible secondary active agents include antibacterial agents, antistatic agents, antisoil and antitstain agents, acaricides, antislip agents, fungicides, enzymes and biologically active agents.

Additionally the carrier fluid foam composition can include an override alkaline builder or buffer agent. The purpose of such a builder is to adjust composition solution pH in order to increase or decrease the rate of active agent decomposition as needed. For example it is desirable to increase the solution pH of active agents selected from the family of alkali metal hypochlorites in order to reduce their decomposition rates and extend their cleanability shelf life. In other instances it may be desirable to increase the solution pH in order to increase the chemical activity and cleanability of the active agent by increasing its rate of decomposition as would be the case with hydrogen peroxide solution. Suitable override alkaline builders include sodium hydroxide, potassium hydroxide, lithium hydroxide, calcium hydroxide, sodium carbonate, potassium carbonate, lithium carbonate, sodium bicarbonate, potassium bicarbonate, lithium bicarbonate and calcium bicarbonate.

As shown in the Examples below, the present inventor found that the fluid foam cleaners disclosed herein provide better cleaning without scrubbing than other known cleaners he tested. Substantially the same superior cleaning results, as were obtained in the cleaning of the mildew stain covered surfaces of the landscaping timbers, are obtained when the fluid foam cleaning compositions of the invention are applied to stained surfaces of painted wood, plastic film, cement, plaster, fabric or the like. In addition, the present functional fluid foam composition, even without the inclusion of a fragrance, was found to mask to a substantial degree, the smell of some active cleaning agents such as sodium hypochlorite and acetic acid. Also, during the application of the present fluid foam composition to a surface, the typical opaque white color of the fluid foam provided an easily seen indicator of whether the cleaner had missed any particular area of the surface. The present inventor further found that the carrier fluid foam cleaner described herein floats, remains stable on water surface for a relatively long time (at least 30 minutes) and continues to clean at the water/wall interface, as in toilet bowl cleaning. The examples also show that many of these advantages of mildew cleaner carrier foam are also applicable to carrier fluid foams of this disclosure when using functional active agents other than alkali metal hypochlorite, including but not limited to sodium hydroxide for oven and range cleaner, acetic acid for calcium deposits remover, oxalic acid for rust remover, citric acid for soap scum remover, hydrogen peroxide for medicinal and cosmetic applications, etc.

Fluid foams having characteristics outside the combination of characteristics set forth above for the present carrier fluid foam exhibit lower ability to perform their designated functions such as removing stubborn stains, oven grease cleaning and rust removing and soap scum removing without brushing or scrubbing. For example, a thick liquid having high relative viscosity is not readily formed into a fluid foam cleaning composition of the invention and is not readily removable from a surface by rinsing. Typically, when such a thick liquid is applied on a surface, scrubbing is required to remove a layer of the cleaner that remains on the surface even after rinsing. A very thick foam (of the consistency of shaving cream), having very low syneresis value does not perform well because it does not carry and release an adequate amount of the active functional agent to the applied surface, even if the vertical clingability of the foam is high. Also a foam that has an excessively large syneresis value (like sudsy water) often is too thin and slippery, which prevents the foam from adhering to the applied surface long enough to accomplish the functional task. A foam having very short horizontal thickness half-life or a very low vertical surface clingability also leaves the applied surface too quickly to allow for adequate functional performance. The inventor found that using the fluorinated hydrocarbon, Dymel® 152 (1,1 difluroethane) manufactured by E.I. duPont de Nemours & Company of Wilmington, Del., as a propellant for a carrier fluid foam comprising sodium hypochlorite, as the active agent, produced a foam which slid down off the applied vertical surface suddenly and completely after 30 seconds (vertical clingability less than one minute). Similarly, a fluid foam prepared using sodium hypochlorite as the active agent and Colonial CF-10 (a low foaming non-ionic) surfactant, marketed by Colonial Chemical Company of south Pittsburgh, Tenn., caused the foam to effervesce and slid off the vertical surface with a vertical clingability of one minute only.

Producing and Dispensing Carrier Fluid Foam

The process for producing a functional composition fluid foam of the present disclosure for a particular active agent typically comprises two-steps. First is the selection of a suitable and compatible surfactant as recited herein before. Second a solution is prepared containing the active agent, the compatible surfactant and other additives if desired, each in the desired concentrations recited herein before. Then the solution is vigorously agitated in the presence of a gas. The vigorous agitation can be achieved with mechanical stirrers, but preferably is provided by the fluidic/pneumatic action of a fluid jet, such as is produced by a mechanical breakup actuator of an aerosol dispenser in the presence of propellant. Preferably, the foam is produced with a low-boiling hydrocarbon propellant in an aerosol dispenser made of materials compatible with the solution. Suitable hydrocarbon propellants include propane, n-butane, isobutane and mixtures thereof in a concentration of 1 to 20% by the weight of the solution, preferably 2-10% by weight. Other suitable propellants include Dimethyl ether, (1,1-Difluoroethane, 1,1,1,2 Tetrafluoroethane, and mixtures thereof. Parts and surfaces of the aerosol dispenser that contact the solution are of active agent-compatible metal, rubber, glass or plastic.

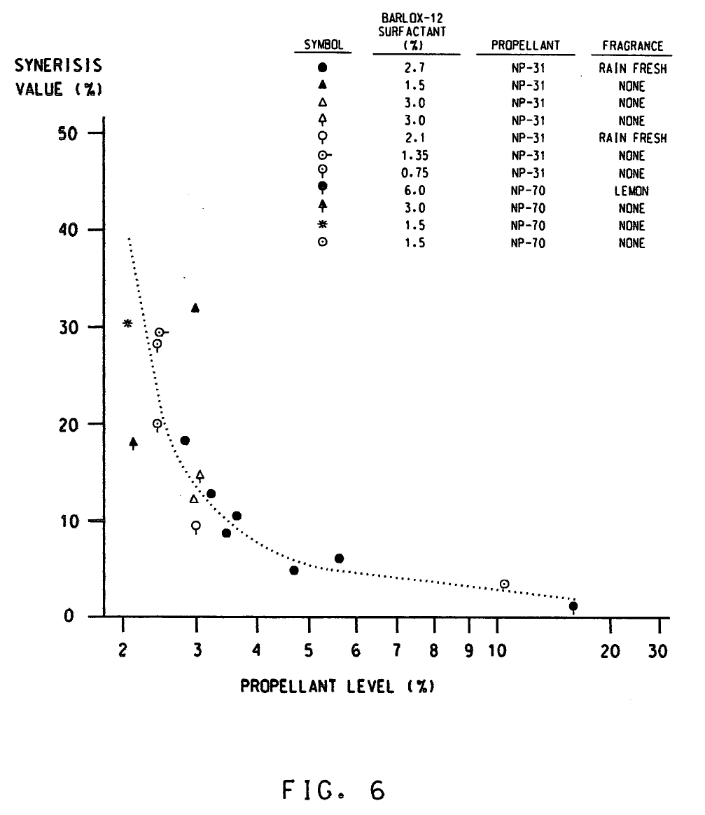

The process parameters, which can be controlled to obtain the desired levels of the three fluid foam functional performance properties of clingability, horizontal thickness half life and synerisis, include: (1) inherent surfactant properties including foaming power and compatibility with the functional active agent; (2) surfactant concentration; (3) propellant concentration; and (4) surfactant and propellant interactions with each other and with other additives. Tables III, IV and V and FIG. 6 in examples 25 and 26 show typical quantitative correlations between the process conditions and the resulting properties of the carrier fluid foam using sodium hypochlorite as the active agent and different surfactants, propellant and fragrances.

The equipment parameters which effect the conversion of the solution composition to the carrier fluid foam of the invention include: (1) the aerosol dispenser having a mechanical breakup actuator at exit nozzle end; and (2) the dispenser container inner surfaces must not adversely interact with the liquid formula with which they are in contact. The inventor found that without satisfying the first condition it is difficult to produce the carrier foam of this invention. Tables VI and VII of examples 27 and 28 presented herein after, show that dispensers with finger trigger pumps, which do not have mechanical breakup actuators, fail to produce foam with clingability larger than 1.5 minutes as compared with clingabilities in the range of 5-64 minutes for the carrier foam produced by aerosol dispensers with mechanical breakup actuators. The inventor also found that using dispenser containers not compatible with any of the composition components such as using containers made of tin plate or aluminum metals, not well protected by plastic liners, with sodium hypochlorite as the active agent, caused the container to fail and start leaking in only few hours even though the carrier foam properties were initially satisfactory.

To convert a functional active agent from a liquid state to the functional composition carrier foam of this disclosure it is desirable to follow these steps: (1) select a surfactant suitable and compatible with the active agent using the criteria and tests described herein before; (2) conduct preliminary agitation tests with the Osterizer to estimate the surfactant goal concentration; (3) prepare a solution comprising the surfactant, the active agent and other additives at the desired concentrations; (4) run additional tests with this solution in the selected aerosol dispenser using different levels of surfactant and propellant; and (5) select the conditions which give you the best combination of carrier foam properties.

An exemplary method of preparing and dispensing the present fluid foam will now be described with particular reference to the aerosol dispenser depicted in FIG. 2. A solution of active agent(s) and a surfactant, in accordance with the concentrations required for the fluid foam composition, is mixed and placed in the container of the aerosol dispenser. The outer wall of the dispenser container typically is of a metal, plastic or glass of sufficient strength to withstand the internal pressures expected during use. The container has optionally an inner liner made of active agent-compatible glass or plastic. Polyethylene, polypropylene, polyamides, polyethylene terephthalaates, polyester, polyacetals, and polymer mixtures such as acetal-trioxane polymers, acrylonitrile-styrene polymers and acrylonitrile-methacrylate polymer are suitable liner materials. A preferred liner is that which is in intimate contact with the dispenser container inner wall as depicted in FIG. 2. A container particularly suited for use with the solutions is commercially available from ALCAN PACKAGING of ALgroup Wheaton of Netherlands. Another suitable container is a Pouch or Barrier Dispenser. This dispenser has a pouch suspended from the dispenser cover within the container and is not in intimate contact with the dispenser container inner wall.

Other exemplary aerosol dispensers suitable for the preparation and delivery of the carrier foam of this invention are similar to the dispenser depicted in FIG. 2 but without the inner liner 21 of the container 20 and optionally without the inner coating or laminate on the inside surface of the container cover 22 provided that the material of construction of the container 20 and the cover 22 are active-agent-compatible and pressure-resistant material. Such materials of construction include metals, glass, high performance plastic and reinforced plastic. Suitable examples include tin plate metal, carbon steel, stainless steel, tantalum metal, titanium metal, thick glass, glass-reinforced plastic, wire reinforced plastic and Kevlar (trade mark for E.I. DuPont De Nemours & Co. high performance aramid fiber) reinforced plastic, which are suitable materials of construction.

The aerosol dispenser, as depicted in FIG. 2, comprises a cylindrical container 20 having a cover (also called a “mounting cup”) 22 attached to the top of the container. The container has an inner liner insert 21 of active agent compatible material. Cover 22 has an active agent-compatible material laminated to its inner surface. Valve components of the aerosol dispenser are pre-assembled to form a valve assembly unit, which includes housing 23, valve stem gasket 24, spring 25, valve stem 26, actuator button 27 containing nozzle 28, and dip tube 29. The valve assembly unit is inserted through an opening in the center of cover 22 and is attached to the cover to form a valve/cover assembly. Then, the pre-assembled valve/cover assembly is installed in the container. The active cleaning agent-compatible material laminated to the circumferential edge of cover 22 is brought into contact with the upper rim of active agent-compatible inner liner 21 of container 20 and then the circumferential edge of cover 22 and the top edge of container 20 are mechanically crimped together, so that the active agent-compatible materials of the cover laminate and the container inner liner form a seal. Optionally, a cover-sealing gasket, not shown in FIG. 2, can be installed. All parts of the aerosol dispenser are made of materials compatible with the liquid composition.

A suitable design of spray valve assembly for installation in the cover of the aerosol dispenser is commercially available from Precision Valve Corporation, Yonkers, N.Y. or from Seaquist Perfect Dispensing of Gary, Ind. In such spray valve assemblies, the housing and valve stem can be made of nylon, the dip tube and actuator button of polyethylene or polypropylene, the valve stem gasket, of an ethylene/propylene copolymer, butyl or of Viton® synthetic rubber (from Dupont Dow Elastomers LLC of Wilmington, Del.) and the coil spring of carbon steel, stainless steel or passivated stainless steel, tantalum or titanium. Typically, the cylindrical container and cover can be made of aluminum, steel (such as carbon steel or stainless steel), tin plate, tantalum, titanium, thick glass, glass reinforced plastic, wire reinforced plastic or Kevlar® (a TradeMark for E.I. DuPont De Nemours & Co. high performance aramid fiber). Optionally, the cover being laminated with a film of polyethylene or polypropylene on its inner surfaces and the cylinder can have an inner liner insert of polyethylene or polypropylene as may be needed for compatibility purposes.

A precursor solution is prepared and mixed. Then the dispenser container is loaded with the solution either by pouring prior to installing the cover and valve spray assembly or by injecting the solution under pressure through the installed cover and spray valve assembly. After the dispenser container is loaded with solution and the cover and spray valve assembly installed and sealed, propellant (usually as liquid) is injected under pressure through the valve assembly into the container where part mixes with solution 30, part floats as a liquid layer 50, atop the solution, and part forms a gaseous phase that fills space 40, thereby providing the pressure needed to drive the solution/propellant mix through the valve assembly when the valve is opened. Suitable propellants include propane, butane, isobutane and mixtures thereof in quantities amounting to 1 to 20% of the weight of the solution among others mentioned above. Other suitable propellants include Diethyl ether, 1,1,-difluoromethane, 1,1,1,2-Tetrafluoroethane and mixtures thereof in quantities amounting to 1 to 20% of the weight of the aqueous solution. Before opening the valve, the dispenser is shaken to mix the propellant with the aqueous liquid in the container. Then, depressing actuator button 27 against spring 25 causes gasket 24 to flex and expose the orifices in the wall of valve stem 26 to pressure, which allows the mix of cleaning composition solution and liquid propellant to flow through valve stem 26, through the passages of button actuator 27 and through nozzle 28. Nozzle 28 has a mechanical break-up actuator insert located just upstream of the nozzle exit. Typically, the mixture emerging from the actuator nozzle is like a mist that when dispensed onto a surface, converts almost immediately to fluid foam of the invention.

Within the actuators of the aerosol dispensers, certain design features can improve sprayed foam formation. Such features include, upstream of the exit nozzle, mechanical breakup mechanisms to reduce spray particle size. Typical break-up mechanisms include a circular or near circular swirl chamber, one or more tangential entries to a chamber, orifices, screens, and/or special exit nozzles. The aerosol dispenser can also include an extension tube, not shown in FIG. 2, which extends from the exit of button 27 and has a mechanical break-up orifice located at the exit end of the extension tube.

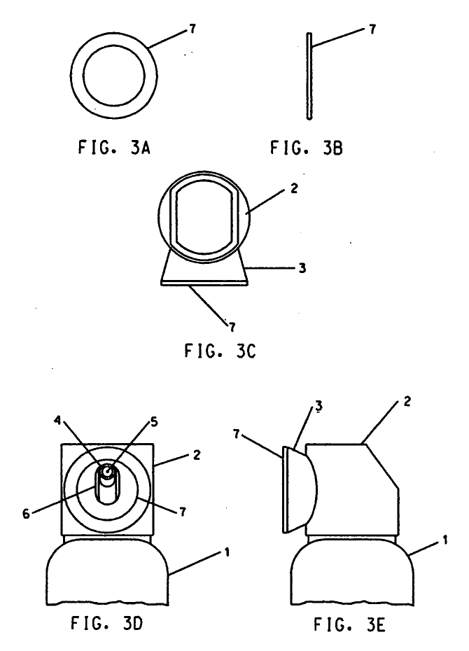

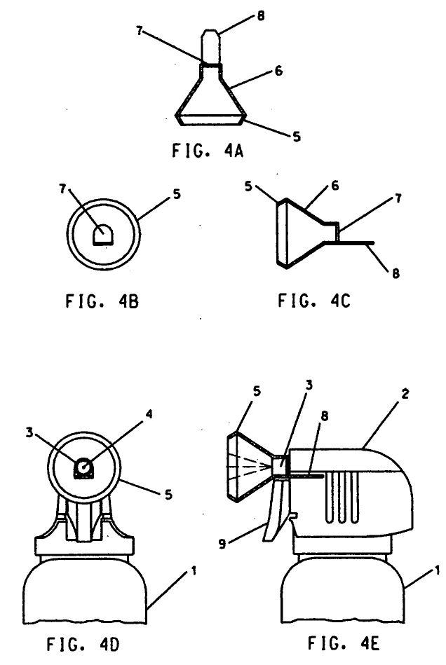

The aerosol dispenser can further include foam drip catcher device as described in FIGS. 3A to 3E and FIGS. 4A to 4E to collect residual foam oozing out of the nozzle after the valve is shut off. FIG. 3A is a front view, and FIG. 3B is a side view of schematic representations of a foam drip catcher dam 7 which is designed to be attached to the front end of the horn 3 of the Sirena® Integrated Spray Cap which is shown in top view in FIG. 3C, in front view in FIG. 3D and in side view in FIG. 3E. Sirena Integrated Spray Cap is in turn mounted on the valve stem 26 of FIG. 2 and is locked in place over the dispenser cylindrical container 1 of FIG. 3D and FIG. 3E. Attaching the foam drip catcher dam to the horn of a Sirena Spray Cap converts it, from being a side shield around the spray jet, to a chamber suitable for catching foam drips. FIG. 3C, FIG. 3D, and FIG. 3E show the location of the drip catcher dam 7 relative to the dispenser can 1, Sirena Spray Cap housing 2, Sirena horn 3, actuator 5, nozzle 4 and horn back opening 6. The latter allows the nozzle to move up or down.

FIG. 4A is a top view, FIG. 4B is a front view and FIG. 4C is a side view of schematic representations of a foam drip catcher chamber designed to be attached to ACC-U-SOL Sprayer as sown in FIG. 4D and FIG. 4E, wherein 1 is an aerosol dispenser can, 2 is an ACC-U-SOL Sprayer, 3 is a nozzle, 4 is an actuator, 5 is a foam drip catcher chamber dam, 6 is a drip catcher chamber, 7 is a back opening of the drip catcher chamber, 8 is a rear arm for mounting the drip catcher chamber onto the ACC-U-SOL Sprayer by sliding it into the space between the nozzle 3 and the top end of the finger trigger, and 9 is a finger trigger.

### EXAMPLES

The following examples illustrate the preparation of several carrier fluid foam compositions of this disclosure and demonstrate the unexpectedly large advantage in enhancing the functional performance of the active agent that these carrier fluid foams possess over known products with the same or similar active agent functionality but in forms other than the carrier fluid foam disclosed herein. The reported results are believed to be fully representative of the present carrier fluid foam with particular emphasis being made on the end use application areas of household cleaning, disinfecting and medicinal applications, but do not constitute all the tests involving these end use applications. The same carrier fluid foam technology disclosed here is equally applicable to other end use application areas including lubrication, agricultural chemicals, industrial chemicals, cosmetic chemicals, and institutional cleaning chemicals end uses. The same good enhancement in performance is expected to result in these other end uses when the same active agent(s) or an active agent(s) with similar functionality is used in the form of the present carrier fluid foam as compared with the active agent in liquid form. The reason for this expectation is that the functionality improvements obtained with the present carrier foams are the direct results of the physical properties of the foam itself and are independent of the specific physical and chemical properties of the functional active agent used. All that is needed is to select the appropriate surfactant for a given active agent having sufficient stability and foaming power, which convert the precursor liquid composition to the present carrier foam when such liquid composition is vigorously agitated in the presence of gas.

In the Examples, carrier fluid foam of the present disclosure was produced by vigorously agitating solution containing a compatible surfactant and the active agent(s), while in contact with a gas, such as air, or a low boiling liquid hydrocarbon propellant. Vigorous agitation was produced by mechanical or fluidic/pneumatic means. Test foams of the invention prepared by vigorous mechanical agitation of liquid solution in the presence of air were produced in an 800-watt AC “Osterizer”, manufactured by Oster Corporation of Milwaukee, Wis., having a 1.2-liter-capacity plastic container. The foam produced by the Osterizer was dispensed to a test panel surface by pouring, by brushing or with a spatula. When vigorous agitation was provided by an aerosol dispenser, a dispenser of the general type illustrated in FIG. 2 was employed. When a commercial cleaning composition was tested, the commercial product was employed in accordance with its manufacturer's instructions and usually applied to the test surface with the manufacturer-supplied plastic hand pumped spray nozzle or other dispensing means. Example 25 demonstrates the flexibility of using different surfactants with the same functional active agent, sodium hypochlorite, to produce the fluid foam of this disclosure.

The Examples demonstrate that hand pumped dispensers of the type common in the art have difficulty providing sufficiently intense mechanical agitation to produce a carrier fluid foam of the present disclosure. Example 26 shows the effects of the process variables of surfactant type, surfactant concentration and propellant concentration on the functional performance properties of clingability, horizontal thickness half-life and syneresis of the fluid foam of this disclosure. These and similar correlations for different composition ingredients are useful in defining the processes required to produce the optimum fluid foam products with different functional active agents. Example 27 summarizes the foam properties of typical current commercial cleaner products evaluated in the Examples. Example 28 summarizes the foam properties of the carrier foams of the present disclosure demonstrated in the Examples.

### Example 1

This example along with Example 2 illustrates the formation of a carrier fluid foam product using hydrogen peroxide as the active cleaning and disinfecting agent. Such carrier foam product should be useful in medicinal applications such as cleansing and simultaneously disinfecting dirty wounds, without scrubbing, and also in cosmetic applications such as in hair dyeing where the oxidizing power of the active agent helps bleach the hair before dyeing. In addition, it can be used in special cleaning applications to remove stains of blood and other organic material.

To a 100 ml commercially available, 3% hydrogen peroxide solution in water, was added 3 ml of 30% aqueous solution of non-ionic surfactant “Barlox 12” cocamine oxide (available from Lonza Specialty Chemical company of New Jersey). The surfactant has an average molecular weight of 249 and is a mixture of N,N dimethyl-1-dodcylamine-N-oxide, N,N-dimethyl-1-tetradecyl-amine-N-oxide, and N,N dimthyl-1 hexadecyl amine-N-oxide. This precursor solution has 3% active agent and 0.9% surfactant (dry basis) with a pH of 3.5. Upon vigorous agitation in the Osterizer at a “Whip” setting for 20 seconds the carrier fluid foam was produced. Measurement of mildew cleanability with 10 minutes treatment time on the landscaping timber, showed no bleaching action at all with a cleanability rating of zero.

### Example 2

This example illustrates the effect of the concentration of the active ingredient, hydrogen peroxide, on foam characteristics and mildew cleanability rating. A series of three 100 ml precursor solutions were prepared with hydrogen peroxide concentrations of 8.8%, 17.7% and 35.4% using 1.5% cocamine oxide surfactant (dry basis). They were whipped in the Osterizer for 30 seconds. The resulting foam properties and cleanabilities of mildew stains on landscaping timber were then measured. The results, which are summarized in Table I, show that good foam properties were obtained in all cases. However, only at the highest concentration used (35.4%), was there any change in color of the mildew stained landscaping timber. The color contrast cleanability rating was 3.5. The treated panel surface changed from gray/black to a reddish color. This degree of color change did not occur immediately upon rinsing with water after 10 minutes. Instead it developed slowly over two hours after rinsing with water. It is known that hydrogen peroxide decomposes to water and oxygen faster at higher solution pH. Therefore it is expected that stronger and faster cleaning actions will be obtained by adjusting the solution pH to higher levels.

TABLE I
Properties of hydrogen peroxide carrier foam at different concentrations

| Concen- | | | horizontal | | Cleanability |
|---|---|---|---|---|---|
| tration | | Clingability | thickness | Syneresis | color |
| (%) | PH | (min.) | half-life (min.) | (%) | difference |
| 8.8 | 5-6 | 11.5 | >44 | 20.5 | 0.0 |
| 17.7 | 2-4 | — | >66 | 15.5 | 0.0 |
| 35.4 | 4-5 | 21.0 | >26 | 19.5 | 3.5 |

(— not measured)

### Example 3

This example along with Example 4 illustrates the preparation of carrier foams in which the active ingredients are rust removers and it demonstrates the effectiveness of these products in removing rust stains in household environments.

In this example a commercial “Rust Stain Remover” liquid solution with unspecified ingredients and a pH of 1.0 (available from Whink Products Company of Eldora, Iowa), was used as the active cleaning agent without further dilution. Cocamine oxide surfactant was added at a concentration of 0.4% (dry basis) and the mixture was vigorously agitated in the Osterizer as in Example 1 to produce the carrier fluid foam for this rust removing formula. With the use of a spatula, the carrier fluid foam was applied to: (1) a toilet bowl surface stained with yellow rusty color; and (2) to sink drain which has crusty rust build up around the metal drain seal. The two stained locations were rinsed with water after 10 minutes without scrubbing. The toilet bowl was found to be completely free of the yellow color. However only one half of the drain crusty deposits was eliminated. The toilet bowl stains were also removed by applying the liquid formula itself using a Q-tip with mild scrubbing.

### Example 4

An aqueous solution was prepared which contained 6.3% oxalic acid and 6.5% cocamine oxide surfactant (dry basis). An amount of 135 g. of this solution was charged into a 40×156 mm. aerosol dispenser of the type illustrated in FIG. 2. Then an amount of 7 grams of NP-31 propellant was injected into the dispenser under pressure. The foam produced from the filled and shaken dispenser had these properties: a pH of 1.0, a horizontal thickness half life of 9 minutes, a clingability of 11.5 minutes and a syneresis of 8%. When this foam was sprayed on orange colored rust stains on the porcelain surfaces of a kitchen sink and a bathroom tub and was allowed to stay on for one hour before rinsing with water, the orange stains were completely eliminated. However when this foam product was applied, for an hour, on a metal washer mounted on the bottom of a bathroom wash sink, which developed several dark brown, thick, and crusty rusty spots around the washer, it reduced the intensity of the rust spots but it did not eliminate them. This suggests that more than one application will be needed to clean such heavy and crusty rust spots.

### Example 5

This example, along with Examples 6, 7 and 8, illustrates the use of selected organic acids as the active ingredients to remove stains made of soap scum, hard water deposits and calcium deposits effectively and without scrubbing.

In this example, the active cleaning agent was acetic acid in the form of a commercial “Distilled White Vinegar” product (diluted with water to 5% acid strength). This solution had a pH of 1.5. The surfactant was also Barlox-12 cocamine oxide used at 1% concentration and the batch volume was 103 ml to which 8 drops of “Fresh” fragrance was added. The Osterizer-produced carrier foam of this active cleaning agent was evaluated as a remover of calcium deposits. In this test, the fluid foam was poured onto the plastic water collection trough found under the water/ice dispenser of a house refrigerator. The plastic grid cover to the trough was also covered with the fluid foam. After 40 minutes the remaining liquid and foam were blotted out and the surfaces were wiped with paper towel. Both the grid and the bottom of the trough, which were covered with heavy calcium deposits at the start of the test, were found to be thoroughly clean and shiny. Previous to this experiment it used to take several hours of treatment with liquid vinegar alone to achieve this level of cleaning.

### Example 6

A precursor solution was prepared from acetic acid, in the form of commercially sold distilled vinegar at 5% acid strength with a measured pH of 1.5, as the active cleaning agent. The solution consisted of 4.7% acetic acid and 2.1% Barlox-12 cocamine oxide surfactant (dry basis) with 10 drops of “Fresh” fragrance added to a total batch size of 215 ml. The Osterizer-produced foam had a syneresis of 22% and a horizontal thickness half-life of 15 minutes. This carrier fluid foam was applied gently, with a fine bristles paint brush, on the inside surface of a shower glass door stained with white looking soap scum. After one hour, it was rinsed with water. The white deposit color disappeared. However in one treated area there remained a uniform translucent layer, which did not rinse away with water but could be easily wiped by hand or paper towel while wet. This suggested that the foam application was left too long before rinsing, which allowed the reaction products of the cleaning process to dry up and re-coalesce into a thin gel-like layer and that a shorter treatment time would be better.

### Example 7

This example is an extension of Example 6 showing that rinsing the treated area before it dries up improves cleanability performance. A precursor solution with 4.5% acetic acid, as the active agent, and 2.7% Barlox-12 cocamine oxide surfactant was converted to a carrier fluid foam by vigorous agitation in the Osterizer. The foam had a syneresis of 30% and horizontal thickness half-life of 15 minutes. As in Example 6, the foam was applied on another soap scum stained area of the same bathroom shower door and this time it was rinsed with water only after 10 minutes from application. Upon drying, the glass surface was completely clean, shiny, transparent and free of white color deposits. Scraping the cleaned surface with a razor blade produced nothing as compared with the untreated area where scraping produced white material hanging at the blade edge.

In another control experiment, the 5% acetic acid solution itself was applied on another stained area of the shower glass door by pouring the liquid directly from the bottle on the stained area and rinsing after 10 minutes from application. The resulting surface was only partially clean with the appearance of reduced, but not eliminated opacity and reduced amounts of razor blade scrapings. This example illustrates the cleaning enhancement benefits obtained when a fluid cleaner is used in the form of the carrier fluid foam of this disclosure.

### Example 8

This example illustrates the use of another organic acid, as the active agent for the preparation of carrier foam product for the removal of soap scum. An aqueous precursor solution containing 8% citric acid and 6.3% cocamine oxide surfactant (dry basis) was first prepared. Then an amount of 135 gram of this solution was charged to a 40 mm×156 mm. aerosol dispenser of the type illustrated in FIG. 2. An amount of 7 g. of NP-31 propellant was then injected into the dispenser under pressure. The carrier foam from this dispenser was then sprayed on the shower glass door, which was covered by vertical streaks of soap scum. The sprayed test area was limited to 7.6 cm.×3.8 cm. (3.0 in.×1.5 in) by a template designed to delineate sharp boundaries. After 10 minutes, the treated area was rinsed with water leaving behind a clear and transparent surface compared to the opaque surrounding area, which was covered with soap sum. The treated area was clear when examined under wet as well as dry conditions. Following this initial small area test, the entire glass door surface, covered by soap scum, was sprayed with this carrier foam and was rinsed 10 minutes later leaving behind a perfectly clean and transparent surface. The properties of this carrier foam were: pH=1, vertical area clingability =19 minutes, horizontal area coverage half life =21 minutes and syneresis =14.5%

### Example 9

This is a cleaner product called “Lime Away” distributed by Reckitt Beckeiser, Inc. of New Jersey. It is claimed to remove lime, calcium and rust. It is delivered by a finger trigger foam pump dispenser valve from a plastic bottle. Its pH was zero (0.0). When this foam is applied on soap scum deposit areas next to those on the vertical shower glass door of the bath room described in Examples 6 to 8 and rinsed after the same period of time, no cleanability improvement whatsoever was observed. By contrast, the carrier foam products described in Example 6 removed soap scum and calcium deposit stains completely in the same treatment periods without scrubbing.

### Example 10

This example illustrates the difference, in key foam properties, between the carrier fluid foam of this disclosure and the foam of an existing commercial cleaner product delivered by an aerosol dispenser. The product is “Scrubbing Bubbles” (distributed by S.C. Johnson, Inc.). The active ingredients in this product are: n-alkyl (60% C14, 30% C16, 5% C18) dimethyl benzyl ammonium chlorides (0.11%), n-alkyl (68% C12, 32% C14, dimethyl ethyl benzyl ammonium chloride (0.11%), inert ingredients and 6% hydrocarbon propellant, with a measured pH=12. The measured foam properties of this product are: horizontal thickness half-life =9 minutes and vertical surface clingability =2 minutes.

### Example 11

This product is “Orange Clean-Degreasing foam” (produced by Orange Glo International, Inc. of Colorado). Its pH was measured at 7. It is delivered from an aerosol dispenser as thick foam. However the foam properties are found to be far outside the range of the carrier fluid foam of the present disclosure. Specifically, the horizontal thickness half life was 5.5 minutes, the vertical clingability was 3 minutes and the syneresis was 0.6% This product foam, the label of which claims to degrease stained surfaces, was tested on oven grease stains. An oven rack grill/pan set, heavily stained with baked grease stains, which accumulated over a period of time from repeated baking, was taken out of the oven and placed on a horizontal plane with the steel grill placed over the aluminum pan. The foam from this cleaner was sprayed over one quadrant of the exposed area of the set in sufficient quantities to form a foam layer about an inch thick covering both the pan and the grill. After about 40 minutes, the pan and the grill were rinsed with water and dried without scrubbing. Comparing the treated quadrant with the adjacent untreated quadrant showed no difference between them in the intensity and distribution of stains.

### Example 12

In this example a carrier fluid foam cleaner was prepared in the Osterizer from a precursor solution consisting of 16% sodium hydroxide as the active agent and 1.8% Barlox-12 cocamine oxide surfactant (dry basis). This carrier fluid foam, which had a syneresis of 26% and a horizontal thickness half life of 31 minutes, was applied on a second quadrant of the stained oven grill/pan set and in the same manner as described in example 11. After 35 minutes the pan and the grill were rinsed with water without scrubbing and dried. The treated grill area became shiny clean and free from stains. Similarly the treated area of the aluminum pan was also completely free of stains. However the aluminum pan was covered with a very thin gray dusty layer, which could easily be removed by gentle dry or wet wiping. This dusty material is believed to be a reaction product of sodium hydroxide with aluminum surface. The wiped surface of the pan was shiny and completely free of stains.

### Example 13

An aqueous solution was prepared comprising 14% sodium hydroxide and 5% Barlox-12 cocamine oxide (dry basis). A 135 g. of this solution was poured into a 40 mm. x156 mm. aerosol dispenser of the type illustrated in FIG. 2. The mounting cup was installed and an amount of 7g. NP-31 propellant was injected under pressure. The foam product from this dispenser was compared, side by side, to a commercial foam product, also delivered from an aerosol dispenser, called “Easy-Off, Fume Free Max Oven cleaner”, distributed by Reckitt Benckeiser, in its ability to remove baked grease stains. The active ingredient in Easy-Off is monoethanolamine. A grease stained aluminum drip pan from a household oven and a porcelain rim of an electrically heated flat burner in a kitchen range were used in this test. Through normal use, these two items were covered with multitudes of dark brown baked grease spots. The drip pan was in a horizontal orientation. The two product foams were sprayed on equal size neighboring areas of about 7.0 cm.×3.5 cm. each, first on the pan and then on the porcelain rim of the burner. After 46 minutes the treated areas were wiped with paper towels. Visual examination of the drip pan showed that: where the applied layer of the carrier foam was thick, the cleaning was thorough. Where it was thinner the cleaning was partial and equal to that obtained with Easy-Off commercial product. On the burner porcelain rim, the area treated with the carrier foam was thoroughly cleaned while the area treated with Easy-Off commercial product was only partially cleaned leaving behind about 75% of the stain spots intact. The properties of the two foam products were compared. The results are shown in Table II below.

TABLE II
Property comparison between grease remover carrier foam of this
invention and Easy-Off Oven Cleaner commercial product

| | | | horizontal | | |
|---|---|---|---|---|---|
| | | Clingability | thickness | Syneresis | Water |
| Product | pH | (min.) | half-life (min.) | (%) | Rinsability |
| Carrier foam | 14 | 64 | >140 | 3.5 | 100% |
| Easy-off | 14 | >70 | 1.0 | ˜17.5 | 0.0% |

It was noted that the carrier foam of this example rinsed out easily with water. It also separated into a distinct layer of foam and a distinct layer of clear solution in the horizontal thickness life test beaker. By contrast, the foam of Easy-Off product dried up on the drip pan, did not rinse out with water and did not separate into two clearly distinct foam and liquid layers in the horizontal thickness life test beaker. Both layers contained gas bubbles suspended in liquid phases. There were more bubbles settled in the upper layer and less bubble settled in the lower layer making for hazy, unclear interfaces. Further, in the vertical clingability test, the residual foam of Easy-Off on the landscaping timber not only did not rinse out with water but it also could not be removed by hard wiping with paper towel.

### Example 14

In this example the same two products compared in Example 13 were compared again in their ability to remove baked grease stains, but under different conditions. A steel rack grill from the same household oven heavily stained with dark brown grease stains, a different area of the same grease stained drip pan and a different area of the same grease stained porcelain burner rim as in Example 13 were used in this example. The grill was placed over and in contact with the drip pan. The grill/pan set was placed in a vertical orientation and the two product foams were each sprayed on equal size neighboring areas of about 10 cm.×10 cm. The porcelain rim of the burner was treated in a horizontal orientation in the same manner as in Example 13. After 46 minutes the treated areas were rinsed with water and wiped with paper towels. The steel grill and the burner porcelain rim were thoroughly cleaned by the carrier foam of his invention. They were cleaned only to about 25% (based on number of grease spots remaining) with Easy-Off product. The drip pan area was cleaned to about 90% by the carrier foam product of this example and only to about 35% by the Easy-Off product

### Example 15

This example along with Examples 16 and 17 illustrate the use of sodium chlorite as a mild bleaching active agent in carrier foam of the present disclosure.

A precursor solution of bleaching agent, sodium chlorite, was prepared by dissolving the solid material in water and adding Barlox-12 cocamine oxide surfactant at formula concentrations of 8.5% sodium chlorite and 1.5% cocamine oxide (dry basis). A carrier fluid cleaning foam produced from this solution by the Osterizer had a syneresis of 18% and a horizontal thickness half-life greater than 50 minutes. This foam was tested for mildew stain cleanability on a stained landscaping timber. The cleanability after 10 minutes application time followed by rinsing with water and drying thoroughly, was 4 color units. The same carrier foam was applied on a concrete surface stained with mildew at the green color stage and allowed to dry without rinsing. This treated concrete area was found to be completely clean 24 hours after application.

### Example 16

This example is similar to that of Example 15 except that the precursor formula concentrations were higher, 27% sodium chlorite as the active agent, and 3.6% Barlox-12 cocamine oxide surfactant (dry basis). The Osterizer-produced foam had a syneresis of 23% and a horizontal thickness half-life of more than 45 minutes. The mildew cleanability rating on a gray stained landscaping timber, with 10 minutes treatment time was 9.6 color units. As a control, the 10 minute cleanability rating of the sodium chlorite solution itself, prior to the addition of surfactant, was only 2 color units when applied on the same landscaping timber. It was observed in both Examples 15 and 16 that the bleaching action was very slow and continued after rinsing with the treated panel becoming cleaner by the hour. The cleanability data reported here were measured 24 hours after rising when the panels were completely dry. Also, the bleaching action spread uniformly and horizontally beyond the area width originally covered by the applied foam. This example, taken along with Example 15, shows that the cleanability of this sodium chlorite as active agent, increases substantially with the use of the carrier fluid foam at the same liquid concentration. The cleanability improved further with increased concentration.

### Example 17

In contrast with the previous two examples, in which the active agent, sodium chlorite sample was about five years old, the active agent in this example was also sodium chlorite but it was produced more recently. The aqueous foam precursor solution contained 10% sodium chlorite and 1.5 Barlox-12 cocamine oxide (dry basis). The foam was produced by whipping this solution in the Osterizer for 30 seconds. The horizontal surface half-life was greater then 55 minutes and the cleanability rating was 3.5. As in Examples 15 and 16, the foam spread horizontally beyond panel boundaries to about twice the original width. It removed the gray colored mildew stain layer. It left behind a pinkish color surface on the landscaping timber but did not bleach the wood surface as does the active agent sodium hypochlorite (described below in Examples 19-22).

### Example 18

This is another example illustrating the conversion of a commercially formulated cleaner liquid to the carrier foam of this invention in order to enhance its performance. The product is “Pine-Sol-Cleaner and Antibacterial”(Distributed by Clorox, Inc. of Oakland, Calif.). This formula as purchased, already has an efficient surfactant in it. By agitating the liquid itself vigorously in the Osterizer without the addition of more surfactant, carrier fluid foam was produced with a syneresis of 29% and a horizontal thickness half-life of more than 47 minutes. By the addition of 2.5% Barlox-12 cocamine oxide surfactant (dry basis), the new carrier fluid foam had a syneresis of 20% and a horizontal thickness half-life of more than 28 minutes. The enhancement in this example is the ability of this carrier foam to adhere to and cling to a vertical surface for long enough time to clean stains and to disinfect more effectively.

### Example 19

In this example and in the following Examples 20 and 21, The active agent in the carrier precursor solution is sodium hypochlorite.

To a 100 ml. of Clorox bleach solution containing 6% sodium hypochlorite, was added 1.0 ml of Barlox-12 solution containing 0.3 g. cocamine oxide (dry basis) as surfactant and 0.5 g. sodium hydroxide as an override alkaline builder. The solution was whipped for only 10 seconds in the Osterizer. The resulting carrier foam had a pH of 14, a horizontal thickness half-life greater than 47 minutes, a syneresis of 37%, a foam vertical clingability of 5 minutes and a 10 minute mildew cleanability of 14 on landscaping timber.

### Example 20

The carrier foam of this example is produced under the same conditions as in Example 19 except that the Barlox-12 surfactant amount was 5.0 ml. equivalent to 1.5 g. cocamine oxide (dry basis) and the whipping time in the Osterizer was 5 seconds only. The resulting carrier foam had a pH of 14, a horizontal thickness half-life longer than 28 minutes, a syneresis of 21%, a foam vertical clingability of 7 minutes and a 10 minute mildew cleanability of 14 on landscaping timber.

### Example 21

The carrier foam of this example is produced under the same conditions as in Example 20 except that sodium hydroxide was not added to the foam precursor solution and the whipping time in the Osterizer was 30 seconds. The resulting carrier foam had a pH of 11-12, a horizontal thickness half-life longer than 40 minutes, a syneresis of 17%, a foam vertical clingability of 29 minutes and a 10 minute mildew cleanability of 14 on landscaping timber.

### Example 22

This example illustrates the role of alkali builder override substances in extending the shelf life of the carrier foam mildew remover product.

A 1090 ml. precursor carrier foam solution was prepared from 1000 ml. aqueous solution of sodium hypochlorite at 6% concentration and 90 ml of Barlox-12 surfactant containing 30% cocamine oxide (dry basis). Each of several aerosol dispensers of the type illustrated in FIG. 2 was filled with 144 g. of this liquid formula and 6 drops of “Lemon Bleach Fragrance. W.S.” supplied by Aromatic Fragrance & Flavors International, Inc. of Marietta, Ga., USA. Following the installation of the mounting cup and valve system, an amount of 4 g. of NP-31 propellant was injected under pressure. The average properties of the foam delivered from these dispensers soon after filling was typically as follows: sodium hypochlorite concentration =5.5%, pH=11.5, Foam vertical clingability =16 minutes, Syneresis =19% and cleanability =14. However after a relatively short shelf storage life of 40 days the performance properties of the foam delivered from these dispensers dropped sharply to: solution pH=9.25, sodium hypochlorite concentration =1.6%, and cleanability =4.4. This sharp drop in performance properties over such a short time resulted from the decomposition of sodium hypochlorite, in the absence of override alkali builder in the solution formula. The presence of alkali builder to bring the initial solution pH to 14 would have extended the performance shelf life substantially. A similar precursor solution formula to which sodium hydroxide was added at a level of 0.5%, as alkali builder, started at foam properties similar to the above formula except for the pH which started at 14 instead of 11.5. As a result, the chemical stability of the carrier foam, improved by more than 10 fold. Instead of 40 days, it took this formula more than 400 days before its foam properties dropped to levels comparable to those obtained at 40 days shelf life without alkali builder override. Specifically the properties dropped to: pH=12.8, sodium hypochlorite concentration to 2.99% and the cleanability rating to 4.8.

### Example 23

It is well known that aerosol foam dispensers continue to ooze out a small amount of foam immediately after use, while the valve is in the off position. This example demonstrates the construction and use of the invention of two foam drip catcher devices which can be attached to existing aerosol spray caps in order to collect the foam residue which oozes out of the dispenser nozzle immediately after use, while the valve is in the off position, and prevents it from dripping on the hand or on other surfaces.

The first drip catcher demonstration was carried out using a Sirena Integrated Spray Cap as illustrated in FIGS. 3A to 3E, whereby flat ring 7 of FIG. 3A and FIG. 3B is attached to the front end of the Sirena horn 3 of FIG. 3C to act as a dam 7, which would stop the foam oozing out of nozzle 4 in FIG. 3D from sliding down and out of the collection chamber formed by the horn/dam system. In actual demonstration the inventor found that the foam oozing out of the nozzle, after turning the valve off, amounts to about two cubic centimeters and is normally held behind the dam, inside the collection chamber. Further the inventor found that this residual foam can either be rinsed away or left inside the collection chamber to dry on its own. The dried residue has negligible volume and does not adversely affect the performance of the nozzle in subsequent uses. In commercial use of this type of foam drip catcher, the dam ring 7 would be expected to be molded as an integral part of the horn of the spray cap. In a preferred embodiment, the requirements for the foam drip catcher include: (1) the chamber must be sufficiently large and the dam be sufficiently wide to hold the foam drip oozing out residue; (2) the front opening of the foam drip catcher be sufficiently large and properly aligned with the nozzle spraying position in order for the expanding foam jet to pass through the chamber freely, without touching the dam edges; and (3) the material of construction be compatible with the foam delivered from the nozzle.

### Example 24

The second drip catcher demonstration was carried out using ACC-U-SOL Sprayer as illustrated in FIGS. 4A to 4E. In this example the foam drip catcher illustrated in FIG. 4A, FIG. 4B and FIG. 4C was first constructed whereby 5 is the dam, 6 is the collection chamber, 7 is the rear opening which fits around the ACC-U-SOL nozzle 3 of FIGS. 4D and 4E, and 8 is a rear arm. In use the rear arm is slipped snuggly in the narrow space between the nozzle 3 and the upper flat end of the finger trigger 9 of FIG. 4E, to attach it to the ACC-U-SOL Sprayer where it is held in place during use. A second method for attaching the foam drip catcher of FIG. 4C is to permanently mold the rear arm 8 as part of the top end of the finger trigger. In a preferred embodiment, the requirements for the foam drip catcher are the same as those mentioned in Example 23 above, namely: (1) the chamber must be sufficiently large and the dam be sufficiently wide to hold the foam drip oozing out residue; (2) the front opening of the foam drip catcher be sufficiently large and properly aligned with the nozzle spraying position in order for the expanding foam jet to pass through the chamber freely, without touching the dam edges; and (3) the material of construction be compatible with the foam delivered from the nozzle.

### Example 25

This example demonstrates the flexibility of using different surfactants with the same functional active agent, sodium hypochlorite, in this case, to produce different carrier foam products which have comparable functional performance parameters for cleaning mildew stains. This series of products was prepared in 40 mm diameter ×156 mm high aerosol dispensers of the type illustrated in FIG. 2, using a solution composition consisting of 7.5% sodium hypochlorite, 3.8% NP-31 propellant and the surfactant types and concentrations listed in table III.

TABLE III
Carrier foam products with same functionality made with
different surfactants.
(— not measured)

| | | Foam functional Performance Properties | | |
|---|---|---|---|---|
| Surfactant | | | | Mildew |
| | % | Clingability | Synerisis | Cleanability |
| name | (dry basis) | (min.) | (%) | (color units) |
| Barlox-12 | 2.5 | 42 | 12 | 11.5 |
| Colatrope SC-45 | 1.0 | 24 | 10 | — |
| Colatrope 1254 | 0.22 | 9 | 9.5 | 14 |

### Example 26

This example provides data trends of the effects of process variables on the functional performance properties of fluid carrier foams from solution compositions comprising sodium hypochlorite as the functional active agent and using Osterizer or aerosol dispensers for foam preparation and delivery. These trends were developed to serve as guides for optimizing the product composition for making the best mildew stain cleaner carrier foam of this invention. These data are presented in tables IV and V and in FIG. 6 below.

TABLE IV
Effect of surfactant type on foam clingability at the same
concentrations of surfactant (3.0% dry basis), sodium
hypochlorite active agent (5.5%) and sodium hydroxide
(0.56%) using the Osterizer for foam production

| Surfactant name | Clingability (min.) |
|---|---|
| Colonial ZF10 | 1.0 |
| Colatrope SC-45 | 4.0 |
| Colatrope 1A2 | 5.0 |
| Barlox 12 | 16.0 |
| Colatrope 1254 | 26.0 |
| Colalux CAO-35 | >25.0 |

TABLE V
Effect of concentrations of specific surfactants on the
functional performance properties of carrier foams
produced by aerosol dispenser with sodium hypochlorite

| | | | Foam functional | | |
|---|---|---|---|---|---|
| | | | performance properties | | |
| Solution composition | | | | Horizontal | |
| NaOCl | NP-31 | Surfactant | Clingability | thickness | Synerisi |
| (%) | (%) | (%) | (min.) | half-life (mIn,) | (%) |

A. Barlox 12 surfactant

| | | | | | |
|---|---|---|---|---|---|
| 5.90 | 3.0 | 0.47 | 17 | >50 | 19.0 |
| 5.85 | 3.0 | 0.98 | 32 | >50 | 17.0 |
| 5.80 | 3.0 | 1.15 | 52 | >50 | 12.5 |
| 5.70 | 3.0 | 1.40 | >35 | >50 | 6.5 |
| 5.60 | 3.0 | 2.20 | >50 | >50 | 8.0 |

B. Colatrope 1245 surfactant

| | | | | | |
|---|---|---|---|---|---|
| 7.50 | 3.8 | 0.11 | 1 | — | — |
| 7.50 | 3.8 | 0.22 | 3 | — | — |
| 7.50 | 3.8 | 0.44 | 15 | — | — |
| 7.50 | 3.8 | 0.88 | 8 | — | — |

(NaOCl) as the active agent and NP-31 as propellant
(— not measured)

The data presented in tables III, IV, V and FIG. 6 lead to these conclusions. For a particular surfactant, the key process conditions for attaining the goal performance properties of the carrier foam product of this invention include: (1) the surfactant itself and the concentrations of the surfactant and the propellant; and (2) the concentration of propellant has an influence on the property of syneresis value.

### Example 27

In this example the foam properties of several representative commercial household cleaners, some of which were cited in the above examples, were measured as they were delivered from their dispensers. Some were delivered using aerosol dispensers and some using a finger trigger pump sprayer. These products are listed below:
A. Professional Easy-off Fume Free Max Oven Cleaner distributed by Reckitt Benckiser, Inc. of Wayne, N.J., U.S.A
B. Orange Clean Degreasing Foam, distributed by Orange Glo International, Inc. of Littleton, Colo., U.S.A.
C. One-Wipe Bathroom Cleaner, distributed by Guardsman Product, Inc. of Grand Rapids, Mich., U.S.A.
D. Scrubbing Bubbles Bathroom Cleaner—Lemon—Removes Soap Scum Easily, distributed by S.C. Johnson & Son of Racine Wis., U.S.A.
E. Foaming Disinfectant Bath Room Cleaner—Cannot Scratch Fiber Glass, distributed by CVS.
F. Scrubbing Bubbles Mildew Stain Remover-Cleans Soap Scum, distributed by S.C. Johnson & Son of Racine Wis., U.S.A.
G. Pine-Sol Cleaner and Antibacterial, Distributed by Clorox Co. of Oakland, Calif., U.S.A.
H. Tilex Mildew Root, distributed by Clorox Co. of Oakland, Calif., U.S.A.
I. Lysol, Disinfectant, All Purpose Cleaner, Cuts Grease, distributed by Reckitt & Colman, Inc. Wayne, N.J., U.S.A.

The foam properties of these household cleaners are presented in Table VI below:

TABLE VI
Foam properties of typical commercial household cleaner products

| | | | | Horizontal | |
|---|---|---|---|---|---|
| | | | Clingability | thickness | Syneresis |
| Product | Sprayer | pH | (min.) | Half-life (min.) | (%) |
| A(*) | aerosol | 14 | >70 | 1.0 | 17 |
| B | aerosol | 5 | 3 | 5 | 0.6 |
| C | aerosol | 12 | 3 | 11 | 7 |
| D | aerosol | 11 | 1 | 11 | 14 |
| E | aerosol | 11 | 1.5 | 9.5 | 6.5 |
| F | finger pump | 14 | 0.1 | 3.5 | 8 |
| G | finger pump | 11 | 0.1 | >49 | 23 |
| H | finger pump | 14 | 0.5 | 6 | 14 |
| I | finger pump | 14 | 1 | 5 | — |

(*)The sprayed foam from this product was viscous. It adhered to the vertical surface and the dried and collapsed foam cells would not rinse with water. In the horizontal thickness beaker test, it did not separate into a clear foam layer and a clear liquid layer. Both layers contained a liquid phase in which bubbles were suspended. It was difficult to discern a phase boundary.
(— not mesured)

### Example 28

In this example the foam properties of the carrier foam products disclosed herein are summarized in Table VII below for easy comparison with the commercial products of Example 27.

TABLE VII
Foam properties of products of the present carrier foam

| example | active | | | | clingability | horiz. thickness | Syneresis |
|---|---|---|---|---|---|---|---|
| No. | agent | surfactant | Produced by | pH | (min.) | half life (min.) | (%) |
| 4 | oxalic acid | Barlox-12 | aerosol spray | 1 | 11.5 | 9 | 8.0 |
| 8 | citric acid | Barlox-12 | aerosol spray | 1 | 19 | 21 | 4.5 |
| 13 | NaOH* | Barlox-12 | aerosol spray | 14 | 64 | >140 | 3.5 |
| 26 | NaOCl** | Barlox-12 | aerosol spray | 14 | 32 | >50 | 17 |
| 27 | NaOCl** | Col.1254*** | aerosol spray | 14 | 15 | — | — |
| 25 | NaOCl** | Col.1254*** | aerosol spray | 14 | 42 | 12 | — |
| 17 | NaOCl** | Barlox-12 | Osterizer | — | >11.5 | >55 | 16 |
| 20 | NaOCl** | Barlox-12 | Osterizer | 14 | 5 | >47 | 37 |
| 21 | NaOCl** | Barlox-12 | Osterizer | 14 | 7 | >28 | 21 |
| 22 | NaOCl** | Barlox-12 | Osterizer | 11.5 | 29 | >40 | 17 |
| 27 | NaOCl** | Barlox-12 | Osterizer | 14 | 20-30 | — | — |
| 2 | hydrogen | Barlox-12 | Osterizer | 2-6 | 11.5-21 | 26-66 | 16-21 |
| | peroxide | | | | | | |
| 27 | NaOCl** | Barlox-12 | finger pump | 14 | 1.5 | — | — |

(symbols: * sodium hydroxide, ** sodium hypochlorite, *** colatrope.1254)
(— not measured)

Many different embodiments of the carrier foam described herein may be made without departing from the spirit and scope of the invention. Therefore, the scope of the invention is not intended to be limited except as indicated in the appended claims.

1. A carrier foam composition comprising a mixture of a functional active agent and a surfactant, characterized by the composition being a fluid foam having, in combination,
a. a syneresis value in the range of 1 to 60%;
b. a foam horizontal thickness half-life of at least 8 minutes;
c. a vertical-surface clingability of at least 4 minutes; and
d. wherein the functional active agent is selected from the group consisting of organic acids, inorganic acids, organic bases, alkali metal hydroxides, straight chain mono-functional alcohols, mono-functional ethers, esters, aldehydes, ketones, carbonates, oxidizing agents, reducing agents, bleaching agents, cleaners, lubricants, household pest control formulations, herbicides, pesticides, fungicides, industrial chemicals, institutional chemicals, medicinal chemicals, cosmetic chemicals, pharmaceutical chemicals, quaternary ammonium compounds, terpenes, mixtures of surfactants and chelating agents, and combinations of two or more of said functional active agents.

2. A carrier foam composition of claim 1 wherein the syneresis value is in the range of 2 to 40%, the foam horizontal thickness half-life is at least 12 minutes, and the vertical-surface clingability is at least 7 minutes.

3. A carrier foam composition of claim 1 wherein the syneresis value is in the range of 15-30%, the foam horizontal thickness half life is at least 15 minutes and the vertical surface clingability is at least 9 minutes.

4. A carrier foam composition of claim 1 wherein the functional active agent is alkali metal hypochlorite and the precursor solution containing an override alkaline builder and having a relative viscosity greater than 3, the syneresis value is in the range of 2 to 40%, the foam horizontal thickness half-life is at least 12 minutes, and the vertical-surface clingability is at least 7 minutes.

5. A carrier foam composition of claim 1 wherein the functional active agent is alkali metal hypochlorite and the precursor solution containing an override alkaline builder, the syneresis value is in the range of 1 to 60%, the foam horizontal thickness half-life is in the range of 8 tol minutes, and the vertical-surface clingability is in the range of 4 to 7 minutes.

6. A carrier foam composition of claim 1 wherein the surfactant is an anionic, cationic, non-ionic or amphoteric compatible surfactant which is incapable of interacting substantially adversely with any of the ingredients of the carrier foam composition or with the dispenser device components with which it comes in contact.

7. A carrier foam composition of claim 6 wherein the surfactant includes at least one of an alkyl amine oxide, an anioinc surfactant with sulfonate and carboxylate functionality, or an anionic hydrotropic surfactant, and the surfactant is present in the solution at a concentration in the range of 0.05 to 20%.

8. A carrier foam composition of claim 6, wherein the surfactant is selected from the group consisting of cocamine oxides, sodium alkyl alkanoate, sodium dodecyl diphenyl disulfonate, cocaminopropyl amine oxide, octyl phenoxy polyethanol, a liquid soap containing ammonium lauryl sulfate and sodium lauryl sulfate, Palmolive® liquid soap, Johnson® baby shampoo and mixtures thereof.

9. A carrier foam composition of claim 6, wherein the surfactant is an anionic surfactant selected from the group of linear and branched alkyl sulphates and sulphonates, alkyl ether sulphates, phosphate esters, fatty acids, soaps and mixtures thereof.

10. A carrier foam composition of claim 6, wherein the surfactant is a cationic surfactant selected from the group of quaternary ammonium compounds, fatty amine salts, fatty acid amides, imidazolines and mixtures thereof.

11. A carrier foam composition of claim 6, wherein the surfactant is a non-ionic surfactant selected from the group of alkyl phenol ethoxylates, alkyl polyglycosides, ethoxylate propoxylate polymers, fatty alcohol ethoxylates and mixtures thereof.

12. A carrier foam composition of claim 6, wherein the surfactant is an amphoteric surfactant selected from the group of alkyl betaines.

13. A carrier foam composition of claim 1, wherein the surfactant is a microfine or nanoparticle active agent selected from the group of polyamides and polymethacrylates.

14. A carrier foam composition of claim 1 wherein the functional active agent is selected from the group consisting of acetic acid, oxalic acid, citric acid, sulfuric acid, hydrochloric acid, nitric acid, phosphoric acid and sulfamic acid and salts thereof.

15. A carrier foam composition of claim 1 wherein the functional active agent is selected from the group consisting amines and salts thereof and salts of ammonia.

16. A carrier foam composition of claim 1 wherein the functional active agent is selected from the group consisting of sodium hydroxide, potassium hydroxide, lithium hydroxide, sodium carbonate, potassium carbonate, calcium carbonate and lithium carbonate, sodium metasilicate and sodium orthosilicate.

17. A carrier foam composition of claim 1 wherein the functional active agent is selected from the group consisting of sodium chloride, potassium chloride, lithium chloride, sodium chlorite, hydrogen peroxide, sodium hypochlorite, potassium hypochlorite and lithium hypochlorite.

18. A carrier foam composition of claim 1 wherein the functional active agent is selected from the group consisting of methyl alcohol, ethyl alcohol, n-propyl alcohol, butyl alcohol and other higher molecular weight straight chain mono-functional alcohols.

19. A carrier foam composition of claim 1 wherein the functional active agent is selected from the group consisting of dimethyl ether, methyl ethyl ether, diethyl ether, and other higher molecular weight mono-functional ethers.

20. A carrier foam composition of claim 1 wherein the functional active agent is selected from the group consisting of methyl acetate, ethyl acetates, propyl acetate amyl acetate, and other higher molecular weight esters.

21. A carrier foam composition of claim 1 wherein the functional active agent is selected from the group consisting of commercially formulated compositions of cleaners, lubricants, household pest control formulations, agricultural herbicide, pesticide and fungicide chemicals, industrial chemicals, institutional chemicals, medicinal chemicals, cosmetic chemicals and pharmaceutical chemicals.

22. A carrier foam composition of claim 21 wherein at least one functional active agent is selected from the group consisting of “Rust Stain remover” by Whink Products Co., “Lime Away” by Reckitt Benkeiser, and “Pine-Sol” by Clorox, Inc., Turtle Wax 2001 foaming wheel cleaner and Turtle Wax platinum ultrabrite wheel cleaner by Turtle Wax, Inc., Chicago, Ill., Black Magic no scrub wheel cleaner by Pennzoil Quaker State Company of Houston, Tex., Eagle one all wheel and tire cleaner by Eagle One, Inc of Lexington, Ky., Grease Lightning auto and shop cleaner degreaser by A&M Cleaning Products of Clemson, S.C., Westleys Bleche white for tires by Blue Coral Stick 50 Ltd of, Bug Wash and Wax by Aiken Chemical Company of Greenville, S.C., Armor All Tire Foam by Armor All Products of Oakland, Calif., F21 Tire foam and shine by 2004 Turtle Wax Inc of Chicago, Ill., Tilex Fresh Shower by Clorox Company of Oakland, Calif., Clean Shower Daily Soap Scum and Mildew Remover by Arm & Hammer Company of Princeton, N.J., Sno Bol toilet bowl cleaner by Church and Dwight Company of Princeton, N.J., Kaboom shower, tub and tile cleaner by Orange Glo International, Littleton, Colo., Clorox bathroom cleaner with Teflon by Clorox Company of Oakland, Calif., Bug and Tar Remover by Letter 1 Products of Lenexa, Kans., BBQ Grill Cleaner by Magic American Products of Cleveland, Ohio, Mr. Clean antibacterial by Procter and Gamble of Cincinnati, Ohio, Simple Green all purpose cleaner by Sunshine Makers of Huntington Beach, Calif., Formula 409 all purpose cleaner by Clorox Company of Oakland, Calif. Grease Lightning orange blast super strength household cleaner by A&M Cleaning Products of Clemson, S.C., Top Job all purpose cleaner by Changing Paradigm, LLC, West Chester, Ohio, Goo Gone all purpose cleaner by Magic American Products, of Cleveland, Ohio, Iron Out rust and stain remover by Iron Out, Inc. of Fort Wayne, Ind., Krude Kutter concentrated cleaner degreaser/stain remover by Supreme Chemicals of GA Inc, of Cumming, Ga., CLR Enhanced Formula Bathroom & Kitchen Cleaner by Jelmar of Skokie, Il, Johnson Wax Professional Bathroom and Bowl Cleaner by 2002 S.C. Johnson Commercial Markets, Inc of Sturtevent, Wis., and Johnson Wax Professional Mildew Remover with Bleach by 2002 S.C. Johnson Commercial Markets, Inc, Sturtvent, Wis.

23. A carrier foam composition of claim 21 wherein at least one functional active agent is selected from the group consisting of Hot-Shot Roach and Ant Killer, distributed by Spectrum Group of United Industries, Inc. Round-Up Weed and Grass Killer, Ready-to-Use, distributed by Monsanto Company Lawn and Garden Products of Marysville, Ohio, Weed-B-Gone, distributed by Ortho Group of Columbus, Ohio., Bug-B-Gone, distributed by Ortho Group of Columbus, Ohio, Triozicide, distributed by Spectrum Group of United Industry, Inc. of Saint Louis, Ohio, Ortho Garden Disease Control, distributed by Ortho Group of Columbus, Ohio., WD-40, distributed by WD-40 of San Diego, Calif., Liquid Wrench Super Penetrant, distributed by Radiator specialty company of Charlotte, N.C., Silicone Multi-Purpose Lubricant, distributed by CRC Industries, Inc. of Warminster, Pa. and Elmer's Slide-All with TEFLON Dry Spray lubricant, distributed by Borden, Inc., Dept. CP, Columbus Ohio.

24. A composition of claim 1 wherein the functional active agent is selected from the group consisting of alkyl dimethyl benzyl ammonium chloride, alkyl dimethyl ethyl benzyl ammonium chloride, alkyl dimethyl ethyl benzyl ammonium bromide, alkyl dimethyl ethyl benzyl ammonium bromide alkyl dimethyl ammonium saccharinate.

25. A carrier foam composition of claim 1 wherein the functional active agent is a mixture of a surfactant and a chelating agent, the surfactant being any surfactant of any hydrophilic-lypophilic balance number suitable for converting a liquid precursor composition to fluid foam and is compatible with the functional active agent.

26. A carrier foam composition of claim 25 wherein the functional active agent is ethylene diamine tetraacetic acid or its salts.

27. A carrier foam composition of claim 1 further including an enhancing agent selected from the group consisting of fragrances, coloring materials, surface shining agents, antibiotic agents, and coagulating agents and two or more such agents.

28. A carrier foam composition of claim 27 wherein the fragrance is selected from the group consisting of “Fresh”, “Rain Fresh”, “Floral”, “Lemon”, “Orange”, “Vanilla”, “Winter Green”, “Cherry”, or “Citrus”.

29. A carrier foam composition of claim 1 wherein the functional active agent is a topically applied liquid medication selected from the group consisting of disinfectants, coagulants, anesthetics, antibiotics, and antibacterial agents.

30. A carrier foam composition of claim 29 wherein the functional active agent is ethyl alcohol, iodine solution, or potassium aluminum sulfate (common alum).

31. A carrier foam composition of claim 1 further including a secondary functional active agent selected from the group consisting of antibacterial agents, antistatic agents, antisoil and anti-stain agents, acarides, antislip agents, fungicides, enzymes, biologically active agents, organic, inorganic and polymeric nanoparticles.

32. A carrier foam composition of claim 1 further including an override alkaline builder or a buffering agent.

33. A carrier foam composition of claim 32 wherein the override alkaline builder is selected from the group consisting of sodium hydroxide, potassium hydroxide, lithium hydroxide, calcium hydroxide, sodium carbonate, potassium carbonate, lithium carbonate, sodium bicarbonate, potassium bicarbonate, and lithium bicarbonate and calcium bicarbonate.

34. A carrier foam composition of claim 1, wherein the vertical-surface clingability is at least 9 minutes.

35. A carrier foam composition comprising a mixture of one or more functional active agents and a surfactant, characterized by the composition being a fluid foam having, in combination,
a. a syneresis value in the range of 1 to 60%;
b. a foam horizontal thickness half-life of at least 9 minutes, and
c. a vertical-surface clingability of at least 4 minutes.

36. A process for preparing a carrier foam composition fluid foam comprising the steps of (a) preparing a liquid mixture comprising a functional active agent, and a surfactant compatible with the functional active agent at a surfactant concentration in the range of 0.05 to 20%, by weight and optionally a compatible fragrance, and (b) vigorously agitating the liquid in the presence of a gas or propellant to form the foam.

37. The process of claim 36 wherein the vigorous agitation of the liquid mixture is performed with mechanical stirrers in the presence of air.

38. The process of claim 36 wherein the prepared liquid mixture is loaded into an aerosol dispenser having a valve assembly, a mechanical breakup actuator and a push button actuator containing a dispenser outlet, and a low-boiling propellant is injected under pressure into the dispenser and the vigorous agitation is performed by passing the mixture through the mechanical break-up actuator.

39. The process of claim 36 wherein the gas or propellant is selected from the group consisting of propane, n-butane, isobutane and mixtures thereof, and the propellant is present in an amount in the range of 1 to 20% of the weight of the solution.

40. The process of claim 36 wherein the gas or propellant is selected from the group consisting of Dimethyl ether, 1,1-Difluoroethane, 1,1,1,2-Tetrafluoroethane, and mixtures thereof in amount in the range of 1 to 20% of the weight of the solution.

41. The process of claims 39 whereby the propellant is used in amount in the range of 2 to 10% of the weight of the solution.

42. The process of claim 38 wherein the aerosol dispenser has an extension tube with an inlet end and exit end, the inlet end of the extension tube being connected to the sprayer cap outlet or to the push button actuator outlet, and the mechanical break-up actuator being located in the exit end of the extension tube.

43. The process of claim 38 wherein the liquid mixture and the propellant are loaded into a pouch suspended within the dispenser, the pouch being separated from the container inner wall of the dispenser.

44. The process of claim 38 wherein the dispenser has a container and a cover, the container and cover being made of active-agent-compatible and pressure-resistant material of construction.

45. The process of claim 44 wherein the materials of construction of the container and cover are selected from the groups of metals, glasses, high performance plastics and reinforced plastics.

46. The process of claim 45 wherein the container and cover are made of Tin plate metal, carbon steel, stainless steel, tantalum metal, titanium metal, thick glass, glass-reinforced plastic, wire reinforced plastic or aramid fiber reinforced plastic.

47. The process of claim 38 wherein the dispenser has a container and a cover, the container and cover being made of metal, the container having an inner liner insert of an active agent-compatible polymer and the cover having laminated to its inner surface a layer of active agent-compatible polymer.

48. The process of claim 38 wherein the dispenser has a foam drip collection device attached to its valve assembly.

49. The process of claim 48 wherein the foam drip collection device is mounted on the valve assembly with a hinge and locks to provide for rotating the drip collection device to a resting position during storage.
